(19) United States
(12) Patent Application Publication
(10) Pub. No.: US 2022/0261746 A1
(43) Pub. Date: Aug. 18, 2022

(54) METHOD FOR MANAGING TEMPERATURE INFORMATION OF TRANSPORTED CARGO, TERMINAL DEVICE, INFORMATION PROCESSING APPARATUS, PROGRAM, AND MANUFACTURING METHOD

(71) Applicant: SYSMEX CORPORATION, Kobe-shi (JP)

(72) Inventors: Yasuhiro OHYAMA, Kobe-shi (JP); Yoshiaki TABATA, Kobe-shi (JP); Takashi ONO, Kobe-shi (JP); Tatsuru WAKIMOTO, Kobe-shi (JP); Shinichi YAMAMOTO, Kobe-shi (JP); Yusaku MATSUO, Kobe-shi (JP); Kenichiro SUZUKI, Kobe-shi (JP); Shinichi IOKA, Kobe-shi (JP); Takehiko AKAKABE, Kobe-shi (JP)

(73) Assignee: SYSMEX CORPORATION, Kobe-shi (JP)

(21) Appl. No.: 17/669,608

(22) Filed: Feb. 11, 2022

(30) Foreign Application Priority Data
Feb. 12, 2021 (JP) 2021-021272
Feb. 7, 2022 (JP) 2022-017348

(51) Int. Cl. G06Q 10/08; H04L 67/1097; G01K 3/04

(52) U.S. Cl. CPC G06Q 10/0832; H04L 2209/38; G01K 3/04; H04L 67/1097

(57) ABSTRACT

Disclosed is a management method for managing temperature information of a transported cargo by a blockchain system. A management method according to one or more embodiments may include: obtaining, by a user terminal used in the blockchain system, data about a temperature from a thermometer transported together with the cargo, and transmitting, by the user terminal, the data to the blockchain system in order to register information about presence or absence of temperature deviation.

### CROSS REFERENCE TO RELATED APPLICATIONS

This application claims priority from prior Japanese Patent Application Nos. 2021-021272, filed on Feb. 12, 2021 and 2022-017348, filed on Feb. 7, 2022, each entitled “METHOD FOR MANAGING TEMPERATURE INFORMATION OF TRANSPORTED CARGO, TERMINAL DEVICE, INFORMATION PROCESSING APPARATUS, PROGRAM, AND MANUFACTURING METHOD”, the entire contents of each of which are incorporated herein by reference.

### FIELD OF THE INVENTION

The present disclosure relates to a method for managing temperature information of a transported cargo, and the like.

### BACKGROUND

U.S. Pat. No. 10,521,806 discloses a technique for managing a temperature history of a cargo being transported, by using blockchain technology.

In the above-described technology, a temperature history of a cargo being transported is managed by using a temperature sensor for detecting a temperature of the cargo, and a smart label, having a WiFi (registered trademark) communication function, for registering information of the temperature detected by the temperature sensor in a blockchain system. However, since a unit price of the smart label having the WiFi communication function is high, in a case where the smart label having the WiFi communication function is packed in each cargo, transportation cost is increased.

### SUMMARY OF THE INVENTION

The scope of the invention is defined solely by the appended claims, and is not affected to any degree by the statements within this summary.

A management method according to a first aspect is a management method for managing temperature information of a transported cargo (6) by a blockchain system (5), and the management method includes: obtaining, by a terminal (7) of a user who uses the blockchain system (5), data about a temperature from a thermometer transported together with the cargo (6), and transmitting, by the terminal (7), the data to the blockchain system (5) in order to register information about presence or absence of temperature deviation, as illustrated in FIG. 1.

A management method according to a second aspect is a management method for managing temperature information of a transported cargo (6) by a blockchain system (5), and the management method includes receiving, by the blockchain system (5), data about a temperature which is obtained from a thermometer transported together with the cargo (6), from a terminal (7) of a user who uses the blockchain system (5), and registering, by the blockchain system (5), information about presence or absence of temperature deviation based on the data, as illustrated in FIG. 1.

A management method according to a third aspect is a management method for managing temperature information of a transported cargo (6) by a blockchain system (5), and the management method includes: obtaining, by a terminal (7) of a user who uses the blockchain system (5), data about a temperature from a thermometer transported together with the cargo (6); transmitting, by the terminal (7), the data to the blockchain system (5); and registering, by the blockchain system (5), information about presence or absence of temperature deviation based on the data, as illustrated in FIG. 1.

A terminal device (7) according to a fourth aspect is a terminal device (7) of a user who uses a blockchain system (5) for managing temperature information of a transported cargo (6), and the terminal device (7) includes a controller (processor 713), and the controller (processor 713) is programmed to obtain data about a temperature from a thermometer transported together with the cargo (6); and transmit the data to the blockchain system (5) in order to register information about presence or absence of temperature deviation, as illustrated in FIG. 1 and FIG. 13.

An information processing apparatus (server 50) according to a fifth aspect is an information processing apparatus (server 50) included in a blockchain system (5) for managing temperature information of a transported cargo (6), and the information processing apparatus (server 50) includes a controller (processor 523), and the controller (processor 523) is programmed to: receive data about a temperature which is obtained from a thermometer transported together with the cargo (6), from a terminal (7) of a user who uses the blockchain system (5); and register information about presence or absence of temperature deviation based on the data, as illustrated in FIG. 1 and FIG. 17.

A program according to a sixth aspect is a program for causing a computer to function as a terminal (7) of a user who uses a blockchain system (5) for managing temperature information of a transported cargo (6), and the program causes the computer to function as a controller programmed to: obtain data about a temperature from a thermometer transported together with the cargo (6); and transmit the data to the blockchain system (5) for registering information about presence or absence of temperature deviation, as illustrated in FIG. 1 and FIG. 14.

A program according to a seventh aspect is a program for causing a computer to function as an information processing apparatus (server 50) included in a blockchain system (5) for managing temperature information of a transported cargo (6), and the program causes the computer to function as a controller programmed to: receive data about a temperature which is obtained from a thermometer transported together with the cargo (6); and register information about presence or absence of temperature deviation based on the data, as illustrated in FIG. 1 and FIG. 18.

A manufacturing method according to an eighth aspect is a method for manufacturing a system (temperature management system 10) for managing temperature information of a transported cargo (6), and the method includes providing a terminal (7) of a user who uses a blockchain system (5) with a program for executing a process of obtaining data about a temperature from a thermometer transported together with the cargo (6), and a process of transmitting the data to the blockchain system (5) to register information about presence or absence of temperature deviation, in order to install the program on the terminal (7), as illustrated in FIG. 1 and FIG. 14.

A manufacturing method according to a ninth aspect is a method for manufacturing a system (temperature management system 10) for managing temperature information of a transported cargo (6), and the method includes providing an information processing apparatus (server 50) included in a blockchain system (5) with a program for executing a process of receiving data about a temperature which is obtained from a thermometer transported together with the cargo (6), and a process of registering information about presence or absence of temperature deviation based on the data, in order to install the program on the information processing apparatus (server 50), as illustrated in FIG. 1 and FIG. 18.

According to one or more embodiments of the invention, cost for transportation of a cargo requiring temperature management, can be reduced.

### BRIEF DESCRIPTION OF THE DRAWINGS

FIG. 1 illustrates an example of a configuration of a temperature management system according to an embodiment;

FIG. 2 illustrates an example in which information of a cargo being transported is transmitted to a blockchain system;

FIG. 3 illustrates an example of a structure of an identification label;

FIG. 4 illustrates an example of a screen displayed on a terminal;

FIG. 5 illustrates an example of a screen displayed on the terminal;

FIG. 6 illustrates an example of a screen displayed on the terminal;

FIG. 7 illustrates an example of a screen displayed on the terminal;

FIG. 8 illustrates an example of a screen displayed on the terminal;

FIG. 9 illustrates another example of a screen displayed on the terminal;

FIG. 10 illustrates another example of a screen displayed on the terminal;

FIG. 11 illustrates an example of a configuration of a blockchain system;

FIG. 12 illustrates an example of a structure of a distributed ledger;

FIG. 13 illustrates an example of a configuration of the terminal;

FIG. 14 illustrates an example of a configuration of an application operating in the terminal;

FIG. 15 illustrates a serial number of a cargo, image data, information about the cargo, position information, and time information, which are associated with each other;

FIG. 16 is a flow chart showing an example of a flow of a process executed by the application operating in the terminal;

FIG. 17 illustrates an example of a configuration of a server;

FIG. 18 illustrates an example of a configuration of an application operating in the server;

FIG. 19 is a flow chart showing an example of a flow of a process executed by the application operating in the server;

FIG. 20 illustrates an example of an identification label according to another embodiment;

FIG. 21 illustrates an example of a configuration in which information stored in a data logger is read by the terminal, and the read information is transmitted to the blockchain system;

FIG. 22 illustrates an example of another configuration in which information stored in the data logger is read by the terminal, and the read information is transmitted to the blockchain system;

FIG. 23 illustrates an example of an identification label according to still another embodiment;

FIG. 24 illustrates an example of an application operating in the server, according to another embodiment;

FIG. 25 illustrates examples of configurations of a logistics management system and a database;

FIG. 26 illustrates an example of a data structure in the case of the database being a relational database;

FIG. 27 illustrates an example of a cargo basic information list;

FIG. 28 illustrates an example of cargo basic information;

FIG. 29 illustrates an example of a product list;

FIG. 30 illustrates an example of a shipment basic information list;

FIG. 31 illustrates an example of shipment basic information;

FIG. 32 illustrates an example of a shipment list;

FIG. 33 illustrates an example of map information;

FIG. 34 illustrates an example of a blockchain history;

FIG. 35 illustrates an example of map information;

FIG. 36 illustrates an example of an application operating in the server, according to another embodiment;

FIG. 37 illustrates an example of a data structure of the database;

FIG. 38 illustrates an example of information of a manageable temperature range associated with a thermometer ID; and

FIG. 39 is a flow chart showing an example of a flow of a process executed by the application operating in the server.

### DETAILED DESCRIPTION OF THE PREFERRED EMBODIMENTS

Hereinafter, embodiments will be described with reference to the drawings.

[Example of Configuration of Temperature Management System 10]

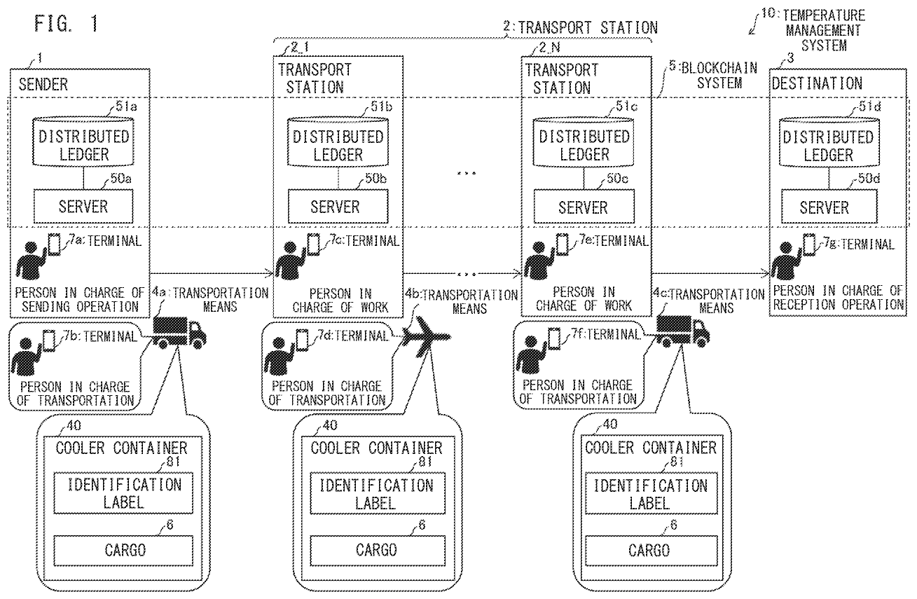

An example of a configuration of a temperature management system 10 according to the present embodiment or embodiments will be described with reference to FIG. 1. The temperature management system 10 in FIG. 1 is applied to a so-called cold chain (low temperature distribution) for transporting a cargo 6 in an environment in which a low temperature is maintained. The temperature management system 10 may be applied to, for example, distribution at normal temperatures as well as the low temperature distribution.

The cargo 6 is required to be transported in an environment in which a low temperature is maintained. The cargo 6 is, for example, a packing box for storing products. Examples of the products include reagents for testing specimens. The products may be reagents for genetic tests, biological raw materials, or pharmaceutical agents. The cargo 6 may be, for example, a packing box in which at least one of a plurality of containers in which reagents for testing specimens are stored, a plurality of containers in which biological raw materials are stored, a plurality of containers in which reagents for genetic tests are stored, and a plurality of containers in which pharmaceutical agents are stored, is packed. For example, the cargo 6 is stored in a cooler container 40 in which a low temperature can be maintained, and is transported. In the cooler container 40, for example, an identification label 81 for detecting or recording change of a temperature to which the cargo 6 is exposed is packed together. That is, the cooler container 40 in which both the cargo 6 and the identification label 81 are stored, is transported.

In a cold chain (low temperature distribution) in which the cargo 6 is transported in an environment in which a low temperature is maintained, the strict temperature management for the above-described products is required. Therefore, information about temperature management and information about the cargo 6 need to be stored at each point of time during transportation of the cargo 6 so as to follow the information about temperature management after arrival of the cargo 6, and authenticity of the stored information needs to be assured. In the temperature management system 10 according to the present embodiment or embodiments, information about temperature management and information about the cargo 6 can be stored at each point of time during transportation of the cargo 6 so as to be followed, and high authenticity of the stored information can be assured.

As illustrated in FIG. 1, the cooler container 40 is stored in transportation means 4a to 4c and transported from a sender 1 to a destination 3. The cooler container 40 is, for example, transported from the sender 1 to the destination 3 via a transport station 2. As illustrated in FIG. 1, the cooler container 40 may be transported via a plurality of the transport stations 2 (transport station 2_1, . . . , transport station 2_N) (N represents an integer of not less than 2). For example, the cooler container 40 may not necessarily be transported via the transport station 2, and may be transported directly to the destination 3 from the sender 1. The sender 1 is, for example, a manufacturing facility for the cargo 6. The transport station 2 is, for example, a logistics station of a transport company. The transport station 2 may be a logistics warehouse or customs clearance. The destination 3 is, for example, a facility of an end user of the cargo 6.

The transportation means 4a to 4c may be changed at each transport station 2. In the example illustrated in FIG. 1, the cooler container 40 is transported from the sender 1 by the transportation means 4a, transported from the transport station 2_1 by the transportation means 4b, and transported from the transport station 2_N by the transportation means 4c. In the following description, in a case where the transportation means are not distinguished from each other, the transportation means is simply referred to as transportation means 4.

The transportation route may be any of a land route, a sea route, and an air route. In a case where the transportation route is a land route, the transportation means 4 is, for example, a truck. In a case where the transportation route is a sea route, the transportation means 4 is, for example, a ship. In a case where the transportation route is an air route, the transportation means 4 is, for example, an aircraft. The transportation means 4 may be a drone.

The sender 1, the transport station 2, and the destination 3 each have a server and a distributed ledger. In the example illustrated in FIG. 1, the sender 1 includes a server 50a and a distributed ledger 51a. The transport station 2_1 includes a server 50b and a distributed ledger 51b. The transport station 2_N includes a server 50c and a distributed ledger 51c. The destination 3 includes a server 50d and a distributed ledger 51d. In the following description, in a case where the servers are not distinguished from each other, the server is simply referred to as server 50. In a case where the distributed ledgers are not distinguished from each other, the distributed ledger is simply referred to as distributed ledger 51.

The server 50 is implemented by a computer and is an information processing apparatus that acts as a node in the blockchain technology. The distributed ledger 51 is a ledger in which transaction data in the blockchain technology is stored. The servers 50 and the distributed ledgers 51 of the sender 1, the transport station 2, and the destination 3 are collectively referred to as a blockchain system 5. The information about the cargo 6 is stored as transaction data in the distributed ledger 51 by the server 50 of each of the sender 1, the transport station 2, and the destination 3, whereby temperature management using the blockchain technology for the cargo 6 is achieved.

Persons who engage in transportation of the cargo 6 use the blockchain system 5. The persons who engage in the transportation of the cargo 6 are, for example, a person in charge of a sending operation in the sender 1, a person in charge of transportation in the transportation means 4, a person in charge of work in the transport station 2, and a person in charge of a reception operation in the destination 3. Each of the persons who engage in transportation of the cargo 6 uses, for example, a terminal 7 held by each person, to transmit information of the cargo 6 to the blockchain system 5. The terminal 7 is not packed in the cargo 6 but is held by each of the users. Thus, information of each of a plurality of the cargos 6 to be transported can be transmitted from the terminal 7 held by each to the blockchain system 5. The terminal 7 is implemented by a smartphone. The terminal 7 may be a tablet terminal or a personal computer. The terminal 7 is preferably a hand-held terminal. However, the terminal 7 is not limited thereto.

In the example illustrated in FIG. 1, a person in charge of a sending operation in the sender 1 uses a terminal 7a to transmit information of the cargo 6 to the blockchain system 5 when the cargo 6 is sent. Specifically, the information is transmitted from the terminal 7a to the server 50 associated with the terminal 7a. The terminal 7a may be associated with a plurality of the servers 50. A person in charge of transportation in the transportation means 4a uses a terminal 7b to transmit the information of the cargo 6 to the blockchain system 5 when the cargo 6 is received from the sender 1 and the cargo 6 is delivered to a person in charge of work in the transport station 2_1. Specifically, the information is transmitted from the terminal 7b to the server 50 associated with the terminal 7b. The terminal 7b may be associated with a plurality of the servers 50. The person in charge of work in the transport station 2_1 uses a terminal 7c to transmit the information of the cargo 6 to the blockchain system 5 when the cargo 6 is received from the person in charge of transportation in the transportation means 4a and the cargo 6 is delivered to a person in charge of transportation in the transportation means 4b. Specifically, the information is transmitted from the terminal 7c to the server 50 associated with the terminal 7c. The terminal 7c may be associated with a plurality of the servers 50. The person in charge of transportation in the transportation means 4b uses a terminal 7d to transmit the information of the cargo 6 to the blockchain system 5 when the cargo 6 is received from the person in charge of work in the transport station 2_1 and the cargo 6 is delivered to a person in charge of work in the transport station 2_N. Specifically, the information is transmitted from the terminal 7d to the server 50 associated with the terminal 7d. The terminal 7d may be associated with a plurality of the servers 50. The person in charge of work in the transport station 2_N uses a terminal 7e to transmit the information of the cargo 6 to the blockchain system 5 when the cargo 6 is received from the person in charge of transportation in the transportation means 4b and the cargo 6 is delivered to a person in charge of transportation in the transportation means 4c.Specifically, the information is transmitted from the terminal 7e to the server 50 associated with the terminal 7e. The terminal 7e may be associated with a plurality of the servers 50. The person in charge of transportation in the transportation means 4c uses a terminal 7f to transmit the information of the cargo 6 to the blockchain system 5 when the cargo 6 is received from the person in charge of work in the transport station 2_N and the cargo 6 is delivered to a person in charge of a reception operation in the destination 3. Specifically, the information is transmitted from the terminal 7f to the server 50 associated with the terminal 7f. The terminal 7f may be associated with a plurality of the servers 50. The person in charge of the reception operation in the destination 3 uses a terminal 7g to transmit the information of the cargo 6 to the blockchain system 5 when the cargo 6 is received from the person in charge of transportation in the transportation means 4c. Specifically, the information is transmitted from the terminal 7g to the server 50 associated with the terminal 7g. The terminal 7g may be associated with a plurality of the servers 50. By using the terminals 7a to 7g of the respective persons in charge, the information of the transported cargo 6 can be sequentially obtained from the terminals 7a to 7g of the respective persons in charge and sequentially transmitted to the blockchain system 5. In the following description, in a case where the terminals are not distinguished from each other, the terminal is simply referred to as the terminal 7. A person who uses the terminal 7 to utilize the blockchain system 5 is simply referred to as “user”.

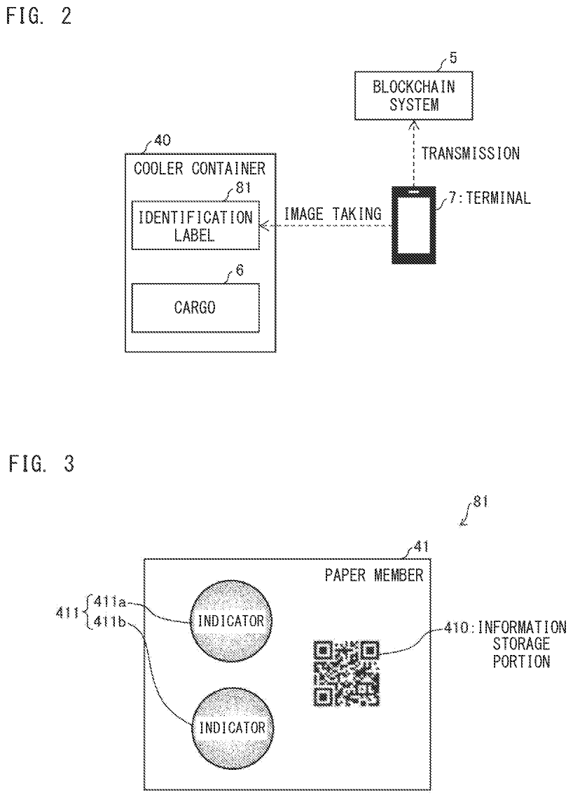

FIG. 2 illustrates an example in which information of the cargo 6 being transported is transmitted to the blockchain system 5. FIG. 2 illustrates an example in which an information code attached to the identification label 81 is read by the terminal 7, the read information is transmitted from the terminal 7 to the blockchain system 5, an image of the identification label 81 is taken by the terminal 7, and the image data obtained by the imaging is transmitted from the terminal 7 to the blockchain system 5. In this case, the terminal 7 has, for example, a reading function, an imaging function, and a communication function. For the communication function of the terminal 7, a cellular communication system as one of wireless communication systems in which base stations are disposed, is used. As the cellular communication system, for example, a communication standard such as 4G (4th Generation (fourth generation mobile communication system)) and 5G (5th Generation (fifth generation mobile communication system)) can be applied. Such a communication standard is preferably used for hand-held terminals such as smartphones, mobile phones, and tablet terminals. The terminal 7 may transmit image data to the blockchain system 5 via, for example, a mobile router connected to the terminal 7.

[Example of Structure of Identification Label 81]

FIG. 3 illustrates an example of a structure of the identification label 81. The identification label 81 includes a paper member 41, a thermometer, and an information storage portion 410. The thermometer measures a temperature by using physical phenomenon of change of physical properties according to change of the temperature, and may qualitatively measure a temperature or may quantitatively measure a temperature. The thermometer of the identification label 81 includes a temperature indicator (hereinafter, simply referred to as “indicator”) 411. As the indicator 411, for example, MELTMARK (registered trademark) (manufactured by NiGK Corporation) is used. As the indicator 411, DIGITALTHERMOTAPE (registered trademark) (manufactured by NiGK Corporation) may be used or a MEDESHILL (registered trademark) label (manufactured by NiGK Corporation) may be used. WarmMark (registered trademark) (manufactured by DeltaTrak) may be used.

The indicator 411 is implemented by, for example, a temperature detecting ink. The temperature detecting ink has characteristics in which its color is changed according to a degree of deviation of a temperature to which a cargo is exposed, from a predetermined management temperature range (for example, 2° to 8° C.), and a time period in which the deviation occurs. In the following description, deviation of a temperature to which the cargo is exposed, from the management temperature range, is abbreviated as “temperature deviation”. The temperature detecting ink has, for example, such irreversibility that, once a color is changed by the temperature deviation, the color is not returned to a previous color. For example, the indicator 411a changes its color (for example, changes the color from a white color to a red color) in a case where the temperature deviates from the upper limit value of the management temperature range in the temperature deviation. Meanwhile, for example, the indicator 411b changes its color (for example, changes the color from a white color to a blue color) in a case where the temperature deviates from the lower limit value of the management temperature range in the temperature deviation.

The information storage portion 410 is implemented by, for example, an information code in which information is stored. The information code is, for example, a QR code (registered trademark). The information code may be a bar code. The information storage portion 410 is, for example, generated by the sender 1 and attached to the identification label 81 when the cargo 6 is sent from the sender 1. The information storage portion 410 may be formed separately from the identification label 81, and may be, for example, attached to the cargo 6. The information storage portion 410 may be transported as a separate portion together with the cargo 6.

In the information storage portion 410, for example, information (for example, serial ID, lot number, expiration date) about the cargo 6 is stored. In the information storage portion 410, identification information, of the identification label 81, generated by a manufacturer of the identification label 81 may be stored. In this case, for example, an information code in which the information (for example, identification number, lot number, expiration date) about the cargo 6 is stored is attached to the cargo 6, and the terminal 7 reads both the information storage portion 410 of the identification label 81 and the information code attached to the cargo 6, to associate identification number of the identification label 81 and the information about the cargo 6 with each other. A temperature of each of a plurality of the cargos 6 stored in the cooler container 40 may be managed by one identification label 81 that is stored in this cooler container 40. In this case, for example, an information code in which the information about the cargo 6 is stored is attached to each of the cargos 6, and the terminal 7 reads the information storage portion 410 of the identification label 81 and the information code attached to each of the cargos 6, to associate the identification number of the identification label 81 and the information about each cargo 6 with each other.

A user operates the terminal 7, and, thus, the terminal 7 reads the information storage portion 410 and takes an image of the indicator 411, for example. The terminal 7 transmits the information read from the information storage portion 410 and image data (data about temperature) obtained by the imaging, to the server 50 of the blockchain system 5.

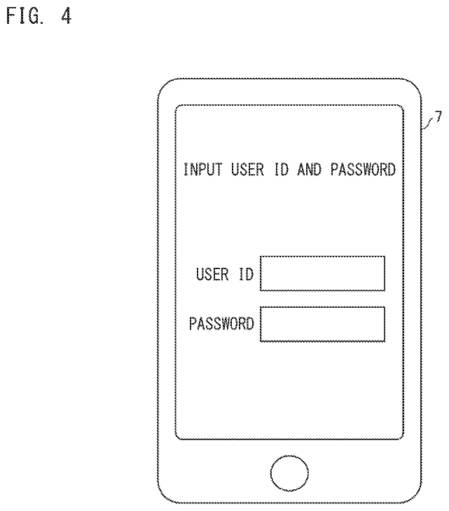

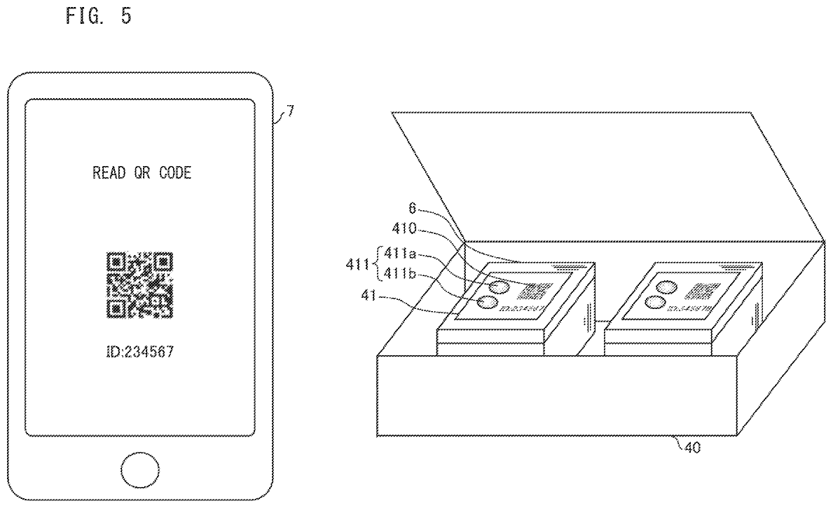

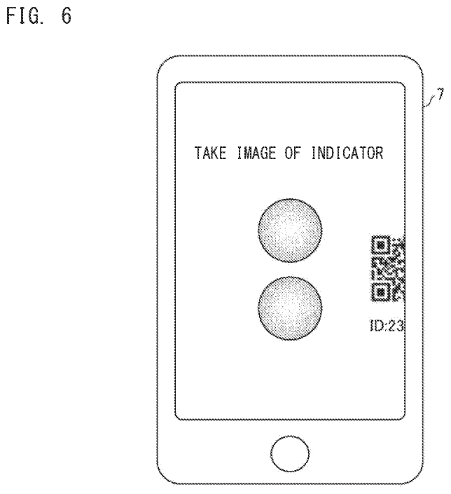

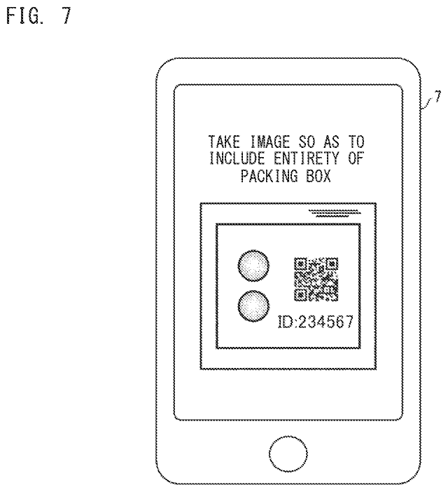

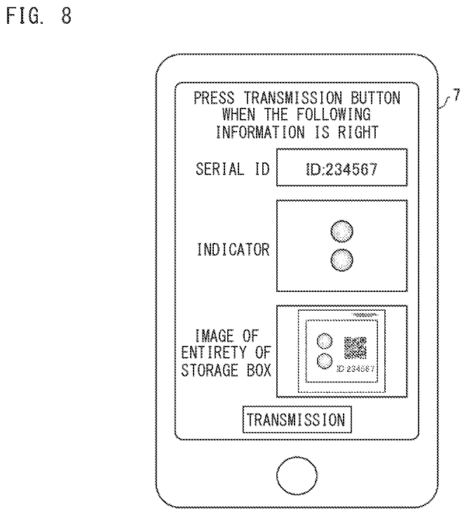

The user operates the terminal 7 according to an operation procedure displayed on the terminal 7, to read the information storage portion 410 and take an image of the indicator 411. FIG. 4 to FIG. 8 illustrate examples of screens displayed on the terminal 7. Firstly, according to contents displayed on the screen in FIG. 4, the user inputs a user ID and a password. The user causes the terminal 7 to read the information storage portion 410 according to contents displayed on the screen, in FIG. 5, which is displayed after the user ID and the password have been inputted. For example, the user operates to read the information storage portion 410 in a state where a lid of the cooler container 40 is opened as illustrated in FIG. 5. The user takes an image of the indicator 411 by using the terminal 7 according to contents displayed on the screen, in FIG. 6, which is displayed after the information storage portion 410 has been read. The screen in FIG. 6 is a screen for an operation of obtaining image data of the indicator 411. The user uses the terminal 7 to take an image including the entirety of the packing box, of the cargo 6, to which the identification label 81 is attached, according to contents displayed on the screen, in FIG. 7, which is displayed after the image of the indicator 411 has been taken. The user performs a transmission operation according to contents displayed on the screen, in FIG. 8, which is displayed after the image of the entirety of the packing box has been taken, whereby the information (for example, serial ID) read from the information storage portion 410, the image data obtained by taking the image of the indicator 411, and the image data obtained by taking the image of the entirety of the packing box are associated with each other and transmitted to the server 50 of the blockchain system 5 by the terminal 7. Thus, the information about temperature management and the information about the cargo 6 can be stored so as to follow the information about temperature management after arrival of the cargo 6, and authenticity of the stored information can be assured. Before transmission to the blockchain system 5, the operation may be allowed to be returned to any of the screens in FIGS. 5 to 7 to re-perform reading and imaging. Imaging of the entirety of the packing box and transmission of the image data obtained by the imaging may be omitted.

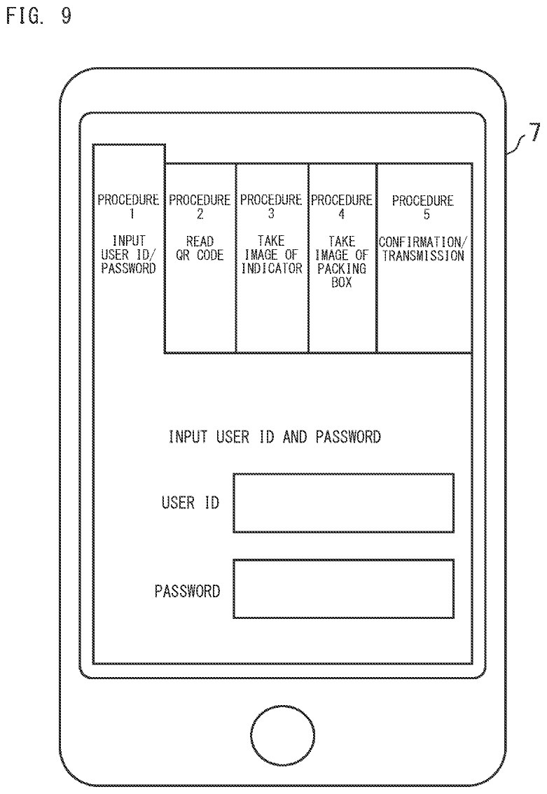

FIG. 9 and FIG. 10 illustrate other examples of screens displayed on the terminal 7. In the example illustrated in FIG. 9, the screen is switched according to a tab, and the tabs displayed as procedures 1 to 5 correspond to the screens illustrated in FIGS. 4 to 8, respectively. In the example illustrated in FIG. 10, the screen is shifted by pressing a button, and the screen is shifted to any of the screens in FIGS. 4 to 8 by pressing the buttons displayed as procedures 1 to 5, respectively.

The terminal 7 is associated with the server 50 of a transmission destination. For example, a communication address (for example, Internet Protocol (IP) address) of the server 50 is set in the terminal 7. The terminal 7 may be associated with a plurality of the servers 50.

For example, in FIG. 1, the information and the image data that are read by the terminal 7a held by a person in charge of the sending operation in the sender 1 when the cargo 6 is sent, are, for example, transmitted to the server 50a,of the sender 1, associated with the terminal 7a, and stored in the distributed ledger 51a by the server 50a.

The information and the image data that are read by the terminal 7b held by a person in charge of transportation in the transportation means 4a when the cargo 6 is received from the sender 1 and the cargo 6 is delivered to a person in charge of work in the transport station 2_1, are, for example, transmitted to the server 50a, of the sender 1, associated with the terminal 7b, and stored in the distributed ledger 51a by the server 50a. The terminal 7b may be associated with the server 50b of the transport station 2_1. In this case, the information and the image data read by the terminal 7b are transmitted from the terminal 7b to the server 50b, and stored in the distributed ledger 51b by the server 50b.

The information and the image data that are read by the terminal 7c held by a person in charge of work in the transport station 2_1 when the cargo 6 is received from the person in charge of transportation in the transportation means 4a and the cargo 6 is delivered to a person in charge of transportation in the transportation means 4b are, for example, transmitted to the server 50b, of the transport station 2_1, associated with the terminal 7c, and stored in the distributed ledger 51b by the server 50b.

The information and the image data that are read by the terminal 7d held by the person in charge of transportation in the transportation means 4b when the cargo 6 is received from the person in charge of work in the transport station 2_1 and the cargo 6 is delivered to a person in charge of work in the transport station 2_N are, for example, transmitted to the server 50b, of the transport station 2_1, associated with the terminal 7d, and stored in the distributed ledger 51b by the server 50b.

The information and the image data that are read by the terminal 7e held by the person in charge of work in the transport station 2_N when the cargo 6 is received from the person in charge of transportation in the transportation means 4b and the cargo 6 is delivered to a person in charge of transportation in the transportation means 4c are, for example, transmitted to the server 50c, of the transport station 2_N, associated with the terminal 7e, and stored in the distributed ledger 51c by the server 50c.

The information and the image data that are read by the terminal 7f held by the person in charge of transportation in the transportation means 4c when the cargo 6 is received from the person in charge of work in the transport station 2_N and the cargo 6 is delivered to a person in charge of the reception operation in the destination 3 are, for example, transmitted to the server 50c, of the transport station 2_N, associated with the terminal 7f, and stored in the distributed ledger 51c by the server 50c. The terminal 7f may be associated with the server 50d of the destination 3. In this case, the information and the image data read by the terminal 7f are transmitted from the terminal 7f to the server 50d, and stored in the distributed ledger 51d by the server 50d.

The information and the image data that are read by the terminal 7g held by the person in charge of the reception operation in the destination 3 when the cargo 6 is received from the person in charge of transportation in the transportation means 4c are, for example, transmitted to the server 50d, of the destination 3, associated with the terminal 7g, and stored in the distributed ledger 51d by the server 50d.

As described above, the temperature management system 10 allows information of the cargo 6 to be stored in the blockchain system 5 at each point of time during transportation of the cargo 6, by using the terminal 7 and the identification label 81 that does not have a communication function such as WiFi. Therefore, as compared with a conventional art in which temperature management for a cargo is performed by using a smart label of which the unit price is high and which is packed together with the cargo, cost for transportation of the cargo 6 can be reduced. The information about temperature management and the information about the cargo 6 can be stored at each point of time during transportation of the cargo 6 so as to follow the information about temperature management after arrival of the cargo 6, and authenticity of the stored information can be assured. The identification label 81 that does not have a communication function such as WiFi is disposable. Therefore, the identification labels 81 need not be collected after transportation of the cargo 6 has been completed. In this case, cost and a procedure for collecting the identification labels 81 after transportation of the cargo 6 has been completed are unnecessary.

[Example of Configuration of Blockchain System 5]

FIG. 11 illustrates an example of a configuration of the blockchain system 5. The servers 50 of the sender 1, the transport stations 2, and the destination 3 configure, for example, a distributed network such as a peer-to-peer network, and can communicate with each other. In FIG. 11, for simplification, only two transport stations 2 (transport station 2_1 and transport station 2_N) are illustrated.

The same information is stored in the distributed ledgers 51 included in the blockchain system 5. For example, in a case where the distributed ledger 51a is updated by the server 50a of the sender 1, the updated contents are transmitted to the server 50b of the transport station 2_1, the server 50c of the transport station 2_N, and the server 50d of the destination 3. The distributed ledger 51b is updated by the server 50b, the distributed ledger 51c is updated by the server 50c, and the distributed ledger 51d is updated by the server 50d. That is, in a case where the distributed ledger 51 is updated by a certain server 50, the updated contents are reflected in all of the distributed ledgers 51 included in the blockchain system 5. Therefore, the same information is stored in the distributed ledgers 51. That is, all the servers 50 included in the blockchain system 5 share the same ledger.

In the example of the configuration in FIG. 11, each of the sender 1, the transport station 2, and the destination 3 includes the server 50 and the distributed ledger 51. However, the blockchain system 5 is not limited to this exemplary configuration. For example, in a case where the sender 1 and a certain transport station 2 are operated by the same operating company, the sender 1 and the transport station 2 may share one server 50 and one distributed ledger 51.

[Example of Structure of Distributed Ledger 51]

FIG. 12 illustrates an example of a structure of the distributed ledger 51. The distributed ledger 51 is structured as a so-called blockchain that includes a plurality of blocks 510. The blockchain has a structure in which the blocks 510 are connected in time series in which data 513 is generated. Each block 510 includes a hash value 511, a number-used-once (nonce) value 512, and the data 513.

The data 513 is transaction data. For example, the data 513 includes information (for example, serial ID, lot number, expiration date) about the cargo 6, information (hereinafter, referred to as “temperature information”) about a temperature of the cargo 6 (for example, information about presence or absence of temperature deviation), position information of the terminal 7, and time information of the terminal 7.

The hash value 511 represents a hash value generated by an immediately preceding block 510 itself. That is, the hash value of each block 510 represents a hash value generated based on contents (that is, the hash value 511, the nonce value 512, and the data 513) of the immediately preceding block 510. The hash value 511 is generated based on a predetermined hash function. The generated hash value varies according to a content of data inputted to the hash function. In a case where data inputted to the hash function is the same, the same hash value is generated.

The hash value 511 generated based on contents of the block 510 serves as information for connecting the blocks 510 to each other. In the blockchain system 5, limitation may be set for the hash value serving as the information for connecting the blocks 510 to each other. For example, only a hash value satisfying a condition that the “high-order three digits are ““000””” can be stored in each block 510. This condition is changed depending on the blockchain system 5.

The nonce value 512 is information used for generating the hash value 511 that satisfies a predetermined condition. Among the information included in the block 510, the data 513, and the hash value 511 of the immediately preceding block cannot be changed. Meanwhile, the nonce value 512 is information that is not associated with the cargo 6 and the transportation, and can thus be changed. Therefore, the nonce value 512 that allows generation of a hash value satisfying the predetermined condition is searched for, by inputting the data 513 and the hash value 511 of the immediately preceding block 510 to the hash function. A new block 510 is structured by the nonce value 512 having been searched for, the data 513, and the hash value 511 of the immediately preceding block 510.

[Example of Configuration of Terminal 7]

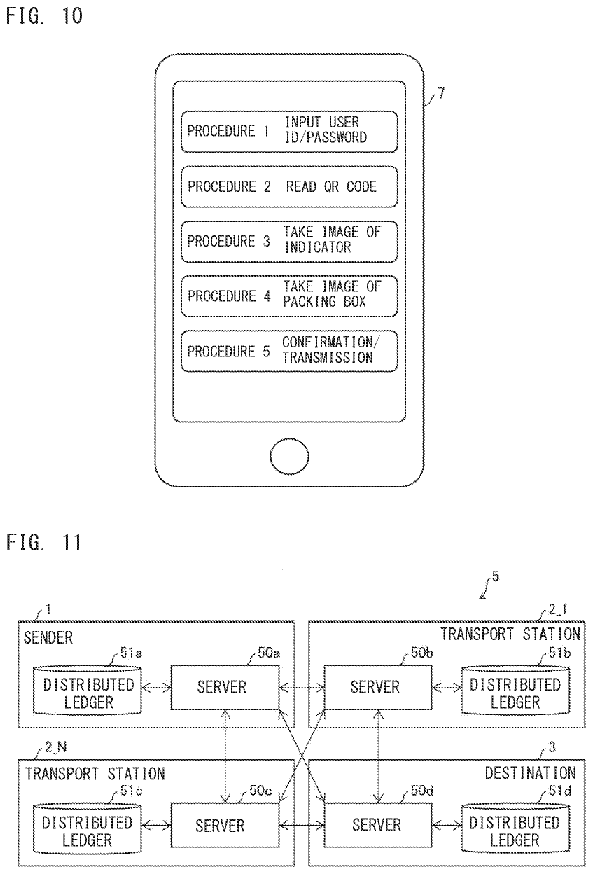

FIG. 13 illustrates an example of a configuration of the terminal 7. The terminal 7 includes, for example, a camera 710, a storage unit 711, a communication unit 712, and a processor 713.

For example, the camera 710 renders an image in a manner in which a light signal is converted to an electric signal by an image sensor such as a charge coupled device (CCD). The storage unit 711 is a memory in which various data and various programs used by the terminal 7 are stored. The communication unit 712 is an interface for performing wired communication or wireless communication with an external communication device under the control of the processor 713.

The processor 713 is a controller for comprehensively controlling the functions of the terminal 7. The processor 713 is, for example, a CPU (central processing unit). The processor 713 executes various processes (hereinafter, simply referred to as “obtaining/transmitting process”) for obtaining, from the identification label 81, information to be registered in the blockchain system 5, and transmitting the obtained information to the server 50 of the blockchain system 5. For example, the processor 713 reads, from the storage unit 711, an application 70 (see FIG. 14) for executing the obtaining/transmitting process, extracts the application 70 into a RAM (random access memory), and executes the obtaining/transmitting process. The application 70 is, for example, stored in the storage unit 711 as a program for causing a computer to function as a controller for executing the obtaining/transmitting process.

The application 70 is, for example, an application dedicated to the blockchain system 5. By operating the application 70 in the terminal 7, the terminal 7 obtains information from the identification label 81 and communicates with the server 50 via the communication unit 712. That is, the terminal 7 obtains information from the identification label 81 by using the application 70, and communicates with the blockchain system 5 via the application 70. The application 70 is, for example, distributed or downloaded from an application providing server to the terminal 7, installed on the terminal 7, and stored in the storage unit 711. Providing the terminal 7 with the application 70 in order to install the application 70 on the terminal 7 is one component of a method for manufacturing the temperature management system 10. The application 70 may be, for example, provided as a Web application by an application providing server, and may operate on a Web browser in the terminal 7.

[Example of Configuration of Application 70]

FIG. 14 illustrates an example of a configuration of the application 70 operating in the terminal 7. The application 70 includes, for example, an image taking portion 71, a code analyzing portion 72, a position information obtaining portion 73, a time obtaining portion 74, an information transmitting portion 75, and an authentication portion 76, in order to execute the obtaining/transmitting process.

The image taking portion 71 has, for example, a function of taking an image of the identification label 81 by using the camera 710. For example, a user starts up the application 70 and performs a predetermined operation, whereby the image taking portion 71 takes an image of the identification label 81. The user takes an image of the identification label 81 by, for example, (1) pressing an icon for causing the camera 710 to take an image and switching a mode of the terminal 7 to an imaging mode, (2) performing adjustment so as to include the identification label 81 in an imaging region of the camera 710, and (3) pressing a shutter button. An imaging target in the identification label 81 is, for example, the indicator 411 of the identification label 81. For example, the image taking portion 71 may determine whether or not the indicator 411 is in the imaging region, and may not receive an imaging operation from a user while the indicator 411 is not in the imaging region.

The code analyzing portion 72 has, for example, a function of reading information stored in the information storage portion 410 by using the camera 710. For example, a user starts up the application 70 and performs a predetermined operation, whereby the code analyzing portion 72 reads information stored in the information storage portion 410. The user performs the reading by, for example, (1) pressing an icon for reading the information storage portion 410, and switching a mode to a mode for reading the information storage portion 410 and (2) performing adjustment so as to include the information storage portion 410 in the imaging region of the camera 710.

The position information obtaining portion 73 has, for example, a function of obtaining position information of the terminal 7 by using a global positioning system (GPS) included in the terminal 7. For example, the position information obtaining portion 73 obtains the position information at a time when an image is taken by the image taking portion 71. The position information obtaining portion 73 may obtain the position information at a time when the code analyzing portion 72 reads information from the information storage portion 410.

The time obtaining portion 74 has, for example, a function of obtaining time information by using a clock function of the terminal 7. For example, the time obtaining portion 74 obtains time information at a time when an image is taken by the image taking portion 71. The time obtaining portion 74 may obtain time information at a time when the code analyzing portion 72 reads information from the information storage portion 410.

The information transmitting portion 75 has, for example, a function of transmitting the following information to the blockchain system 5 via the communication unit 712. That is, the terminal 7 transmits the following information to the blockchain system 5 by using the application 70.

Image data (data about temperature) obtained by the image taking portion 71.

Information (for example, information (serial ID, lot number, expiration date) about the cargo 6) read by the code analyzing portion 72.

Position information obtained by the position information obtaining portion 73.

Time information obtained by the time obtaining portion 74.

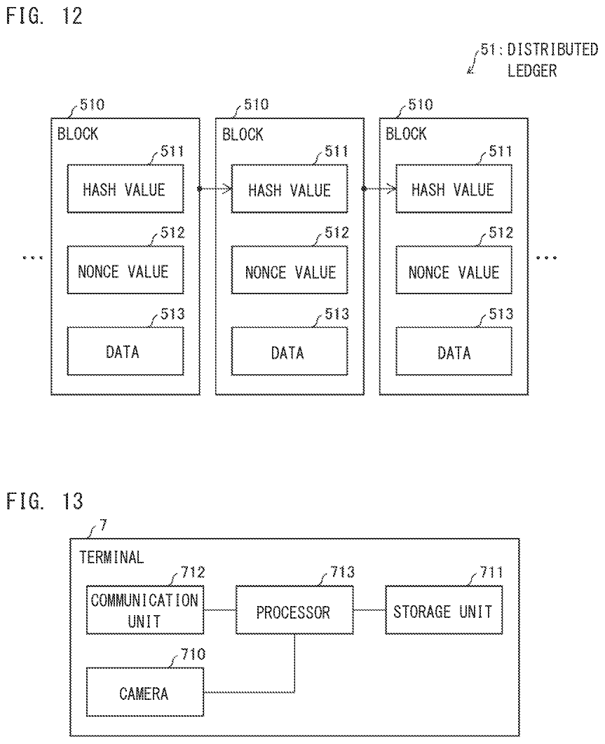

As illustrated in FIG. 15, the image data, the information (in the example in FIG. 15, lot number, expiration date) about the cargo 6, the position information, and the time information are associated with each other and transmitted to the blockchain system 5 by the information transmitting portion 75 by using a serial ID of the cargo 6 as a key.

For example, the information transmitting portion 75 transmits the information to the server 50 associated with the terminal 7 among the servers 50 included in the blockchain system 5. For example, in a case where the terminal 7 is a terminal of an operating company of the sender 1, the terminal 7 transmits the information to the server 50a of the sender 1. For example, a communication address (for example, IP address) of the server 50 to which the information is to be transmitted is set in the information transmitting portion 75, and the information transmitting portion 75 transmits the information to the server 50 having the communication address.

The authentication portion 76 performs authentication of a user who uses the application 70. For example, the authentication portion 76 requests a user to input an ID and a password when the application 70 is started up. The authentication portion 76 may perform the user authentication by using biometric authentication (for example, fingerprint authentication, face authentication). The authentication portion 76 may request the server 50 to perform the user authentication process. For example, the authentication portion 76 permits communication of the information transmitting portion 75 with the server 50 only when the authentication has succeeded. Thus, the terminal 7 permits communication with the blockchain system 5 according to the application 70 when the authentication of a user has succeeded.

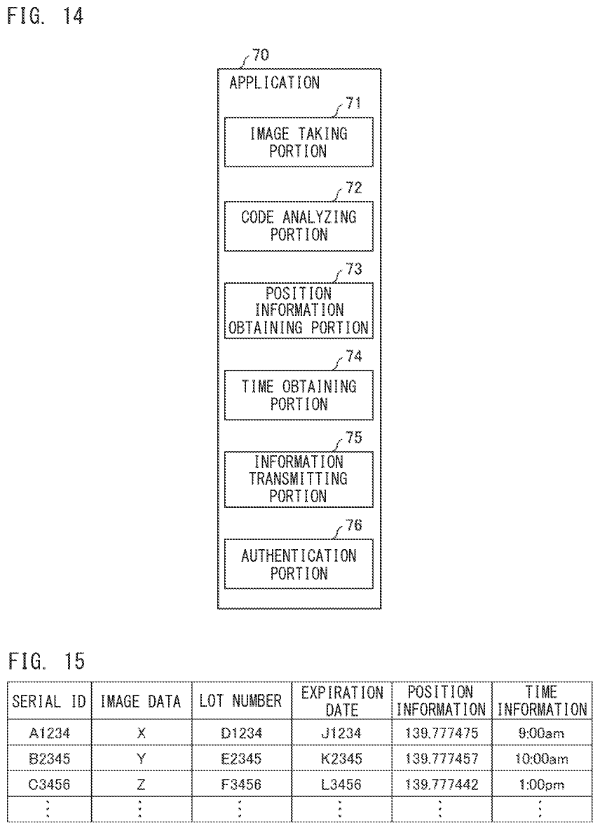

FIG. 16 is a flow chart showing an example of a flow of the process executed by the application 70. Firstly, the code analyzing portion 72 reads information stored in the information storage portion 410 according to an operation performed by a user (S100). The image taking portion 71 takes an image of the indicator 411 according to an operation performed by the user (S101). S100 and S101 may be executed in the reverse order. The position information obtaining portion 73 obtains the position information of the terminal 7 (S102). The time obtaining portion 74 obtains the time information of the terminal 7 (S103). S102 and S103 may be executed in the reverse order. Finally, the image data obtained in S101, the information read from the information storage portion 410 in S100, the position information obtained in S102, and the time information obtained in S103 are transmitted to the blockchain system 5 by the information transmitting portion 75 (S104).

[Example of Configuration of Server 50]

FIG. 17 illustrates an example of a configuration of the server 50. The server 50 includes, for example, a storage unit 521, a communication unit 522, and a processor 523.

The storage unit 521 is a memory in which various data and various programs used by the server 50 are stored, and is, for example, implemented by a magnetic disk such as a hard disk. The communication unit 522 is an interface for performing wired communication or wireless communication with an external communication device under the control of the processor 523.

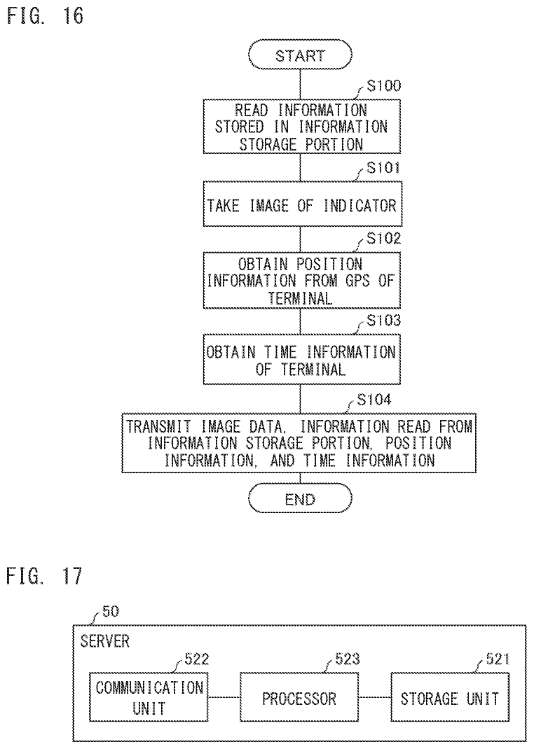

The processor 523 is a controller for comprehensively controlling the functions of the server 50. The processor 523 is, for example, a CPU. The processor 523 executes various processes (hereinafter, simply referred to as “management process”) for managing the distributed ledger 51. The management process includes, for example, a process of receiving information from the terminal 7, a process of updating the distributed ledger 51 based on the information received from the terminal 7, a process of updating the distributed ledger 51 according to the distributed ledger 51 being updated by another server 50, and a process of reading information stored in the distributed ledger 51 according to a request from the terminal 7. For example, the processor 523 reads an application 500 (see FIG. 18) for executing the management process, from the storage unit 521, extracts the application 500 into a RAM, and executes the management process. The application 500 is stored in, for example, the storage unit 521 as a program for causing a computer to function to execute the management process.

The application 500 is, for example, an application dedicated to the blockchain system 5. By operating the application 500 in the server 50, the server 50 communicates with the terminal 7 via the communication unit 522 and accesses the distributed ledger 51. The application 500 is, for example, distributed or downloaded from an application providing server to the server 50, installed on the server 50, and stored in the storage unit 521. Providing the server 50 with the application 500 in order to install the application 500 on the server 50 is one component of the method for manufacturing the temperature management system 10.

[Example of Configuration of Application 500]

FIG. 18 illustrates an example of a configuration of the application 500 operating in the server 50. The application 500 includes, for example, an information receiving portion 501, an image analyzing portion 502, a nonce searching portion 503, a hash generation portion 504, a block generation portion 505, and a distributed ledger updating portion 506, in order to execute the management process.

The information receiving portion 501 receives, for example, the following information from the terminal 7 via the communication unit 522.

Image data (data about temperature) obtained by the image taking portion 71 of the terminal 7.

Information (for example, information (serial ID, lot number, expiration date) about the cargo 6) read by the code analyzing portion 72 of the terminal 7.

Position information obtained by the position information obtaining portion 73 of the terminal 7.

Time information obtained by the time obtaining portion 74 of the terminal 7.

The image analyzing portion 502 has a function of analyzing the image data received by the information receiving portion 501. The image analyzing portion 502 analyzes, for example, a color of the indicator 411 by analyzing the image data. The image analyzing portion 502 generates, for example, temperature information to be stored in the data 513, based on the result of the image analysis. The temperature information indicates whether or not the temperature deviation has occurred. For example, the image analyzing portion 502 generates the temperature information indicating “0” in a case where the result of the image analysis indicates that the temperature deviation has not occurred. Meanwhile, for example, the image analyzing portion 502 generates the temperature information indicating “1” in a case where the result of the image analysis indicates that the temperature deviation has occurred.

For example, the image analyzing portion 502 determines whether or not the temperature deviation has occurred, based on an RGB value of each pixel in the image data. For example, the image analyzing portion 502 performs binarization for the image data based on a threshold value corresponding to a color of the indicator 411 in the case of the temperature deviation having occurred. For example, the threshold value is set as an RGB value, of the color of the indicator 411, corresponding to the temperature deviation. For example, ranges of values of R, G, B, respectively, are set for the threshold value. For example, R is set to 250 to 255, G is set to 0 to 50, and B is set to 0 to 10. For example, in a case where an RGB value of a pixel is within a range of the threshold values indicating the temperature deviation, the image analyzing portion 502 sets the RGB value of the pixel to (0, 0, 0). For example, in a case where an RGB value of a pixel is outside the range of the threshold values indicating the temperature deviation, the image analyzing portion 502 sets the RGB value of the pixel to (255, 255, 255). For example, in a case where the result of the binarization indicates that the number of the pixels in which the RGB value is (0, 0, 0) is greater than a predetermined number, the image analyzing portion 502 determines that the temperature deviation has occurred. Meanwhile, for example, in a case where the result of the binarization indicates that the number of the pixels in which the RGB value is (0, 0, 0) is not greater than the predetermined value, the image analyzing portion 502 determines that the temperature deviation has not occurred.

The nonce searching portion 503 has a function of searching for the nonce value 512. For example, the nonce searching portion 503 searches for the nonce value 512 by which the condition of the hash value 511 in the blockchain system 5 is satisfied. For example, the nonce searching portion 503 searches for the nonce value 512 by which the hash value 511 of the block 510 to be generated satisfies the condition, based on the hash value 511 of the immediately preceding block 510 and the data 513 of the block 510 to be generated. For example, the nonce searching portion 503 randomly generates a numerical value as a random number, and confirms whether or not the condition is satisfied. The nonce searching portion 503 repeats this process until the nonce value 512 satisfying the condition is found. For example, the nonce searching portion 503 retrieves the blocks 510 stored in the distributed ledger 51 by using, as a key, information (for example, the serial ID of the cargo 6) received by the information receiving portion 501. For example, the nonce searching portion 503 recognizes, as “the immediately preceding block”, the block 510 located at the latest location, among the blocks 510 (for example, the blocks 510 having the same serial ID stored therein) having been retrieved. The nonce searching portion 503 may recognize “the immediately preceding block” based on the retrieval result by another function (for example, the hash generation portion 504, the block generation portion 505, the distributed ledger updating portion 506).

The nonce searching portion 503 may request another computing resource to search for the nonce value 512. For example, the nonce searching portion 503 may request another server 50 included in the blockchain system 5 to search for the nonce value 512. For example, the nonce searching portion 503 may request a system for providing a service for searching for the nonce value 512 to search for the nonce value 512. In a case where another computing resource is requested to search for the nonce value 512, for example, the nonce searching portion 503 encrypts the hash value 511 and the data 513 and makes the request. The nonce searching portion 503 may establish a virtual private network (VPN) and then transmit the hash value 511 and the data 513 to another computing resource.

The hash generation portion 504 generates the hash value 511 of the block 510 (that is, the hash value 511 to be stored in the subsequent block 510 that is connected subsequent to the above-described block 510). For example, the hash generation portion 504 calculates the hash value 511 according to a predetermined hash function. For example, the applications 500 of the respective servers 50 included in the blockchain system 5 use a common hash function. For example, the hash generation portion 504 retrieves the blocks 510 stored in the distributed ledger 51 by using, as a key, information (for example, serial ID of the cargo 6) received by the information receiving portion 501. For example, the hash generation portion 504 recognizes, as “the immediately preceding block”, the block 510 located at the latest location, among the blocks 510 (for example, the blocks 510 having the same serial ID stored therein) having been retrieved. The hash generation portion 504 generates the hash value 511 to be stored in the subsequent block 510 that is connected subsequent to the generated block 510, by using the hash value 511 of the recognized block (immediately preceding block). The hash generation portion 504 may recognize “the immediately preceding block” based on the retrieval result of another functional block (for example, the nonce searching portion 503, the block generation portion 505, the distributed ledger updating portion 506).

The block generation portion 505 generates the block 510. For example, the block generation portion 505 generates the block 510 that includes the hash value 511 generated by the hash generation portion 504, the nonce value 512 searched for by the nonce searching portion 503, and the data 513. The data 513 includes, for example, the temperature information (presence or absence of the temperature deviation) generated by the image analyzing portion 502 and the following information received by the information receiving portion 501.

Information (for example, information (serial ID, lot number, expiration date) about the cargo 6) read by the code analyzing portion 72 of the terminal 7.

Position information obtained by the position information obtaining portion 73 of the terminal 7.

Time information obtained by the time obtaining portion 74 of the terminal 7.

Image data (or information indicating a link to the image data) obtained by the image taking portion 71 of the terminal 7.

For example, the block generation portion 505 retrieves the blocks 510 stored in the distributed ledger 51 by using, as a key, information (for example, serial ID of the cargo 6) read by the code analyzing portion 72. For example, the block generation portion 505 recognizes, as “the immediately preceding block”, the block 510 located at the latest location, among the blocks 510 (for example, the blocks 510 having the same serial ID of the cargo 6) having been retrieved. The block generation portion 505 generates the block 510 connected subsequent to the block 510 located at the latest location, by using the hash value 511 of the recognized block (the immediately preceding block). The block generation portion 505 may recognize “the immediately preceding block” based on the retrieval result of another functional block (for example, the nonce searching portion 503, the hash generation portion 504, the distributed ledger updating portion 506).

The distributed ledger updating portion 506 updates the distributed ledger 51. For example, the distributed ledger updating portion 506 registers, in the distributed ledger 51, the block 510 that is newly generated by the block generation portion 505. The distributed ledger updating portion 506 has, for example a function of synchronizing the distributed ledgers 51 with each other. For example, the distributed ledger updating portion 506 notifies the other servers 50 that the distributed ledger 51 has been updated according to the block 510 being newly generated by the block generation portion 505. For example, the distributed ledger updating portion 506 also stores the updated contents in the distributed ledger 51 of the server 50 in which the distributed ledger updating portion 506 operates, according to the distributed ledger being updated by another server 50. For example, the distributed ledger updating portion 506 retrieves the blocks 510 stored in the distributed ledger 51 by using, as a key, information (for example, serial ID of the cargo 6) read by the code analyzing portion 72. For example, the distributed ledger updating portion 506 recognizes, as “the immediately preceding block”, the block 510 located at the latest location, among the blocks 510 (for example, the blocks 510 having the same serial ID of the cargo 6) having been retrieved. The distributed ledger updating portion 506 connects the block 510 for which the distributed ledger 51 is to be updated, to the recognized block (the immediately preceding block). Thus, for example, chain-like connection is obtained such that the blocks 510 having the same serial ID of the cargo 6 are associated with each other. The distributed ledger updating portion 506 may recognize “the immediately preceding block” based on the retrieval result of another functional block (for example, the nonce searching portion 503, the hash generation portion 504, the block generation portion 505).

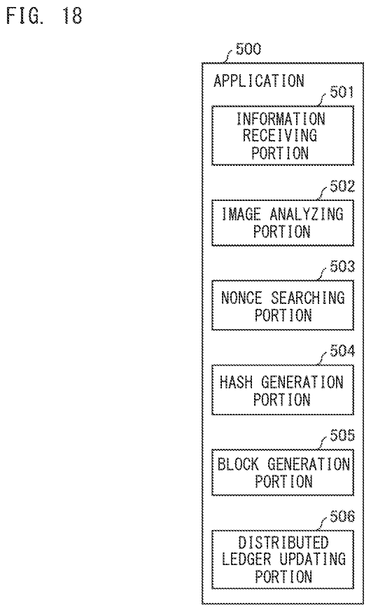

FIG. 19 is a flow chart showing an example of a main flow of the process executed by the application 500. Firstly, the information receiving portion 501 receives the image data of the identification label 81, the information read from the information storage portion 410, the position information of the terminal 7, and the time information of the terminal 7, from the terminal 7 (S200). Subsequently, the image analyzing portion 502 analyzes the image data and determines whether or not the temperature deviation has occurred (S201). Subsequently, the nonce searching portion 503 and the hash generation portion 504 search for a nonce value satisfying a predetermined condition (S202). Subsequently, the block generation portion 505 generates a new block 510 that includes the hash value 511 of the immediately preceding block 510, the nonce value having been searched for in S202, and the data 513 based on the information received in S200 (S203). Finally, the distributed ledger updating portion 506 adds the block 510 generated in S203 to the distributed ledger 51 to update the distributed ledger 51 (S204).

[Example of Identification Label According to Another Embodiment]

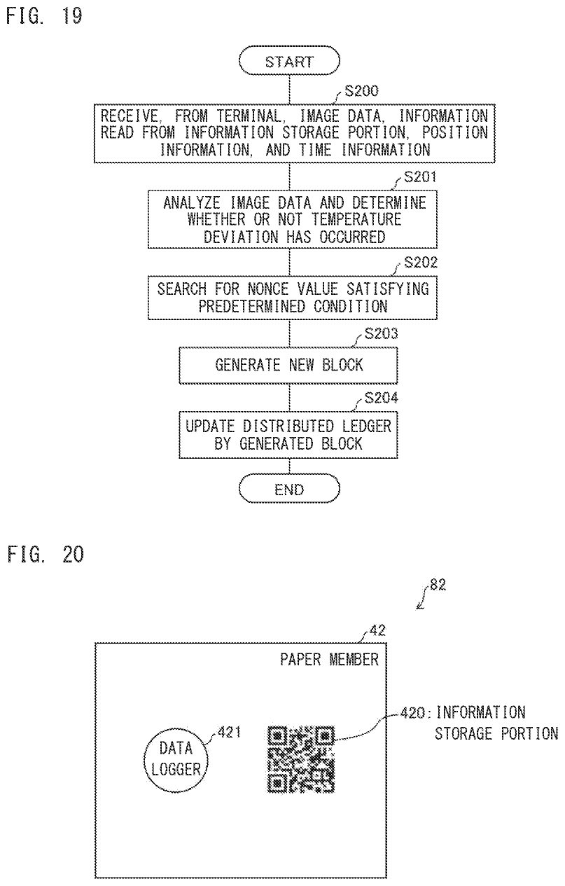

FIG. 20 illustrates an example of an identification label according to another embodiment or embodiments. An identification label 82 illustrated in FIG. 20 has a function of measuring temperatures to which the cargo is exposed at predetermined time intervals and storing the temperatures. The identification label 82 allows a history of temperatures of the cargo 6 being transported to be stored in the blockchain system 5, without providing the identification label 82 itself with a communication function such as WiFi.

The identification label 82 includes a paper member 42, a thermometer, and an information storage portion 420. The thermometer of the identification label 82 includes a data logger 421. The identification label 82 has a structure in which the data logger 421 is attached to a card-shaped member. For the data logger 421, for example, Thermo Button (registered trademark) (manufactured by NiGK Corporation) is used. The Thermo Button has a temperature sensor, a memory, a clock, and a battery incorporated therein, and starts measuring a temperature at a time when a button disposed at the Thermo Button is pressed, and automatically measures temperatures at predetermined time intervals, so that information about a temperature history or temperature deviation can be stored. The data logger 421 stores, for example, a time, and a temperature to which the cargo is exposed at the time, at predetermined time intervals. That is, the data logger 421 measures temperatures of the cargo 6 being transported at predetermined time intervals and stores the temperatures. The stored information can be read by a dedicated reader. The reader is connected to, for example, a USB interface of the terminal 7. The reader is oriented toward the Thermo Button, whereby information stored in the Thermo Button is read by software, for reading, installed on the terminal 7. Thus, the terminal 7 reads, from the data logger 421, information about a plurality of times, and data about a temperature to which the cargo is exposed at each time. That is, the record of the temperatures obtained by measuring temperatures of the cargo 6 being transported at predetermined time intervals is read from the data logger 421. The reading from the data logger 421 is executed by, for example, the transport station 2 and the destination 3.

For the data logger 421, TrekView (registered trademark) (manufactured by SHOCKWATCH) may be used. The TrekView can store information about a temperature history or temperature deviation, similarly to the Thermo Button, and the stored information can be read by a non-contact type reader. For the data logger 421, a logger capable of performing contactless communication with the terminal 7 by a radio frequency identifier (RFID) may be used.

The information storage portion 420 is attached to the identification label 82. The information storage portion 420 is implemented by, for example, an information code in which information is stored, similarly to the information storage portion 410. The information code is, for example, a QR code. The information code may be a bar code. In the information storage portion 420, for example, information (for example, serial ID, lot number, expiration date) about the cargo 6 is stored.

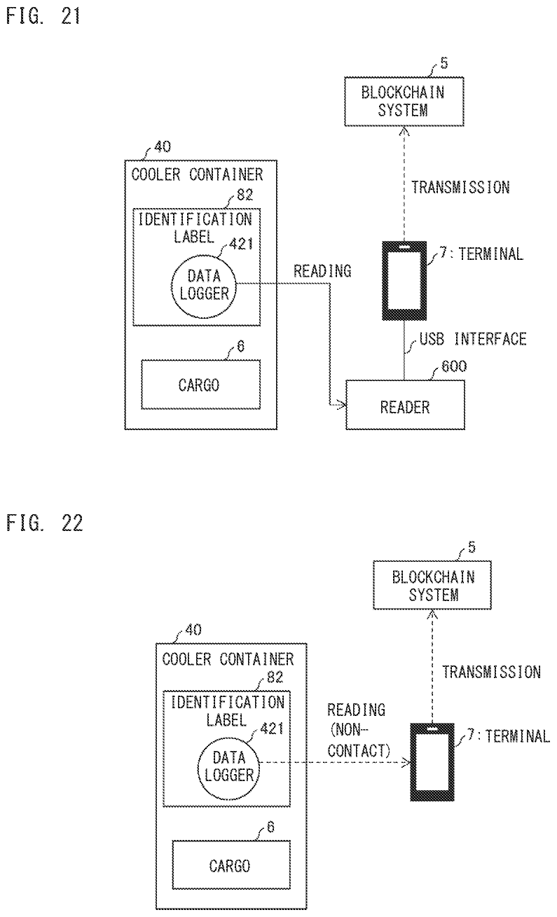

FIG. 21 illustrates an example of a configuration in which the terminal 7 reads the information stored in the data logger 421 and transmits the read information to the blockchain system 5. As in the example illustrated in FIG. 21, the information stored in the data logger 421 is read by a reader 600. The reader 600 is connected to, for example, a USB interface of the terminal 7. The terminal 7 takes in the information read by the reader 600 via the USB interface from the reader 600. The information taken in the terminal 7 is transmitted via the communication unit 712 to the blockchain system 5 by the application 70 of the terminal 7.

FIG. 22 illustrates an example of another configuration in which the terminal 7 reads the information stored in the data logger 421 and transmits the read information to the blockchain system 5. As in the example illustrated in FIG. 22, the information stored in the data logger 421 may be read in a non-contact manner by, for example, a near field communication (NFC) function of the terminal 7.

As described above, by using the identification label 82 and the terminal 7, information of the cargo 6 can be stored in the blockchain system 5 at each point of time during transportation of the cargo 6. Therefore, as compared with a conventional art in which temperature management for a cargo is performed by using a smart label of which the unit price is high and which is packed together with the cargo, cost for transportation of the cargo 6 can be reduced. The information about temperature management and the information about the cargo 6 can be stored at each point of time during transportation of the cargo 6 so as to follow the information about temperature management after arrival of the cargo 6, and authenticity of the stored information can be assured. The identification label 82 that does not have a communication function such as WiFi is disposable. Therefore, the identification labels 82 need not be collected after transportation of the cargo 6 has been completed. In this case, cost and a procedure for collecting the identification labels 82 after transportation of the cargo 6 has been completed are unnecessary.

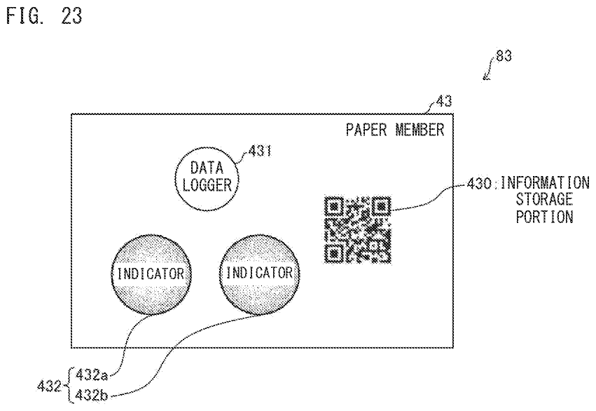

FIG. 23 illustrates an example of an identification label according to still another embodiment or embodiments. An identification label 83 illustrated in FIG. 23 has both the function of the identification label 81 in FIG. 3 and the function of the identification label 82 in FIG. 20. The identification label 83 includes a paper member 43, a thermometer, and an information storage portion 430. The thermometer of the identification label 83 includes a data logger 431 and an indicator 432. The data logger 431 has a function of measuring temperatures to which the cargo is exposed at predetermined time intervals and storing the temperatures. The data logger 431 can be configured in the same manner as for the above-described data logger 421. The indicator 432 has characteristics in which its color is changed according to a temperature to which the cargo is exposed being changed. The indicator 432 has the same configuration as the above-described indicator 411. For example, an indicator 432a changes its color (for example, changes the color from a white color to a red color) in a case where the temperature deviates from the upper limit of the management temperature range in the temperature deviation. Meanwhile, for example, an indicator 432b changes its color (for example, changes the color from a white color to a blue color) in a case where the temperature deviates from the lower limit of the management temperature range in the temperature deviation. The information storage portion 430 is implemented by, for example, an information code in which information is stored, similarly to the above-described information storage portions 410 and 420. The information code is, for example, a QR code. The information code may be a bar code. In the information storage portion 430, for example, information (for example, serial ID, lot number, expiration date) about the cargo 6 is stored.

By using the identification label 83 and the terminal 7, information of the cargo 6 can be stored in the blockchain system 5 at each point of time during transportation of the cargo 6. Therefore, as compared with a conventional art in which temperature management for a cargo is performed by using a smart label of which the unit price is high and which is packed together with the cargo, cost for transportation of the cargo 6 can be reduced. The information about temperature management and the information about the cargo 6 are stored at each point of time during transportation of the cargo 6 so as to follow the information about temperature management after arrival of the cargo 6, and authenticity of the stored information is assured. The identification label 83 that does not have a communication function such as WiFi is disposable. Therefore, the identification labels 83 need not be collected after transportation of the cargo 6 has been completed. In this case, cost and a procedure for collecting the identification labels 83 after transportation of the cargo 6 has been completed are unnecessary.

The identification label 83 includes the data logger 431 and the indicator 432. Therefore, for example, an operation can be performed such that reading of information stored in the data logger 431 is executed by only a part of the destination 3, and the temperature information based on the taken image of the indicator 432 is managed in the other transport stations. That is, an operation can be performed such that reading of information stored in the data logger 431 is executed by only a part of the destination 3 and the like, and only presence or absence of the temperature deviation is managed based on the taken image of the indicator 432 by the transport stations 2 and the like.

[Modification of Identification Label]

The application 500 of the server 50 may have a function of confirming whether or not the identification label 81, 82, 83 has been changed in an unauthenticated manner.

As in the examples of the above-described embodiments, the identification labels 81, 82, 83 include the information storage portions 410, 420, 430, respectively. For example, the identification information of the identification labels 81, 82, 83 is stored in the information storage portions 410, 420, 430, respectively. The identification information of the identification labels 81, 82, 83 may be provided to the identification labels 81, 82, 83 separately from the information storage portions 410, 420, 430, respectively. For example, the identification information of the identification labels 81, 82, 83 may be stored in information codes different from the information codes of the information storage portions 410, 420, 430, respectively.

For example, the terminal 7 reads the identification information of the identification labels 81, 82, 83 from the information storage portions 410, 420, 430, respectively, and transmits the identification information to the application 500. The application 500 registers, in the distributed ledger 51, the block 510 in which the data 513 includes the identification information of the identification label 81, 82, 83 transmitted from the terminal 7. For example, when the identification information transmitted from the terminal 7 is registered in the distributed ledger 51, whether or not the identification information stored in the data 513 of the block 510 which has been previously registered coincides with the identification information transmitted from the terminal 7 is determined by the application 500. For example, if the identification information does not coincide with each other, the identification label is determined, by the application 500, to have been changed.

It is also considered that replacement of the thermometer is required for a justifiable reason such as damage to the thermometer or a dead battery of the data logger. In this case, for example, the terminal 7 transmits, to the application 500, image data of the thermometer which has not been replaced yet, identification information of the thermometer, and the identification information of a thermometer which has replaced the above-described thermometer. For example, in a case where it is determined that the temperature deviation does not occur, based on the image data of the thermometer which has not been replaced yet, the identification information of the thermometer registered in the distributed ledger 51 is changed by the application 500.

[Example of Application 500 According to Another Embodiment: Providing of Graphical User Interface (GUI)]

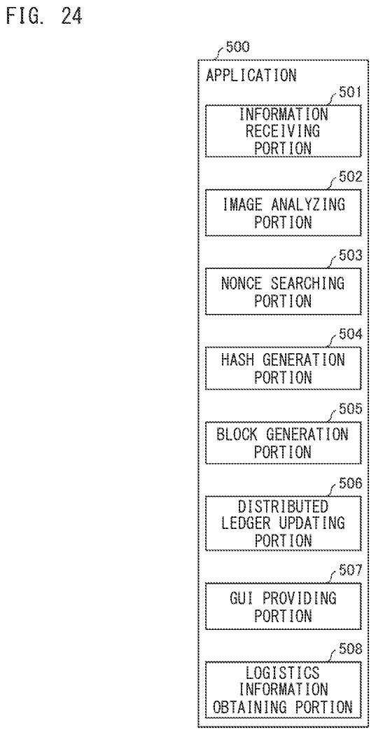

FIG. 24 illustrates an example of the application 500 according to another embodiment or embodiments. The application 500 according to the example of the present embodiment or embodiments includes, for example, a GUI providing portion 507 and a logistics information obtaining portion 508, in addition to the information receiving portion 501, the image analyzing portion 502, the nonce searching portion 503, the hash generation portion 504, the block generation portion 505, and the distributed ledger updating portion 506.

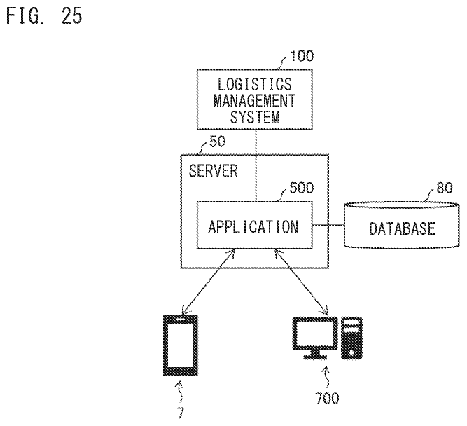

The GUI providing portion 507 has, for example, a function of providing a GUI for displaying information about transportation of the cargo 6. The GUI is provided to, for example, the terminal 7 and a terminal 700 illustrated in FIG. 25. The terminal 700 is implemented by a computer, for example, by a personal computer used by an office worker of a company that engages in management of transportation of the cargo 6. In the following description, a person who utilizes the blockchain system 5 by using the terminal 700 is also referred to as “user”. An example of the GUI provided by the GUI providing portion 507 will be described below.

The logistics information obtaining portion 508 has, for example, a function of obtaining information about logistics for the cargo 6 from a logistics management system 100 illustrated in FIG. 25. The logistics management system 100 is a system different from the blockchain system 5, and the information about the cargo 6 is registered in the logistics management system 100. The information managed by the logistics management system 100 will be described below. For example, the information obtained from the logistics management system 100 is stored in a database 80 illustrated in FIG. 25 by the application 500. The database 80 is, for example, a relational database (RDB).

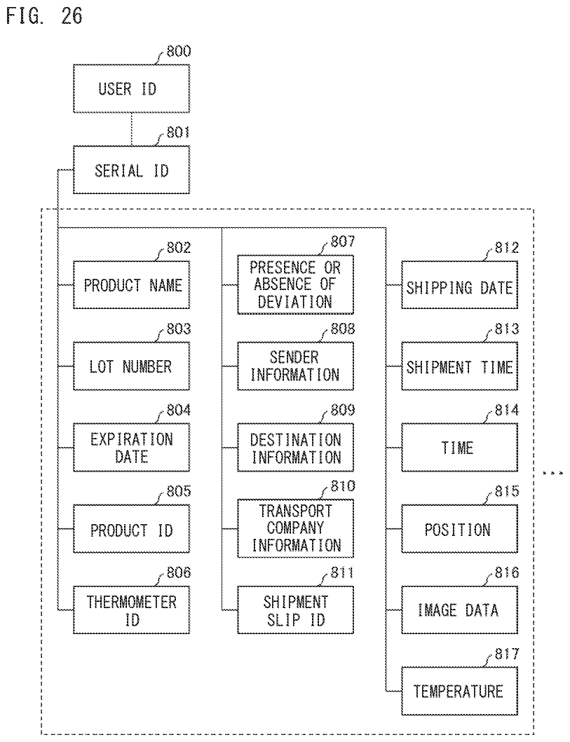

FIG. 26 illustrates an example of a data structure in the case of the database 80 being an RDB. User ID 800 is, for example, ID of a user who uses the blockchain system 5. The user ID 800 is, for example, ID of the sender 1, ID of a company of the transportation means 4, ID of the destination 3, or ID of a company that engages in transportation management. The user ID 800 is, for example, associated with serial ID 801 of the cargo 6 that is handled by a user identified by the user ID 800. The serial ID 801 is, for example, associated with information of (1) to (16) described below.

(1) Product name 802: a name of a product transported as the cargo 6, and the product name 802 is represented by, for example, text.

(2) Lot number 803: a lot number of the cargo 6, and the lot number 803 is represented by, for example, a combination of a numeric character, an alphabet character, and a symbol.

(3) Expiration date 804: an expiration date of the cargo 6.

(4) Product ID 805: an identification number of a product stored in the cargo 6. The product is, for example, each of a plurality of reagents stored in the cargo 6. In the database 80, a plurality of product IDs 805 may be associated with the serial ID 801 of the cargo 6.

(5) Thermometer ID 806: an identification number of a thermometer packed together in the cargo 6. The thermometer ID 806 is registered in the logistics management system 100 when the cargo 6 is sent, and is obtained from the logistics management system 100 by the application 500. The thermometer ID 806 may be read by the terminal 7 from the information storage portion 410, 420, 430 attached to the identification label 81, 82, 83 and transmitted to the server 50.

(6) Presence or absence of deviation 807: information about presence or absence of the temperature deviation. The information represents, for example, “0” indicating that the temperature deviation does not occur, or “1” indicating that the temperature deviation has occurred.

(7) Sender information 808: identification information of the sender 1, for example, ID or a name of the sender 1. For example, the sender information 808 is represented by a combination of a numeric character, an alphabet character, and a symbol in the case of ID, and is represented by text in the case of a name.

(8) Destination information 809: identification information of the destination 3, for example, ID or a name of the destination 3. For example, the destination information 809 is represented by a combination of a numeric character, an alphabet character, and a symbol in the case of ID, and is represented by text in the case of a name.

(9) Transport company information 810: identification information of a company of the transportation means 4, for example, ID or a name of the company. For example, the transport company information 810 is represented by a combination of a numeric character, an alphabet character, and a symbol in the case of ID, and is represented by text in the case of a name.

(10) Shipment slip ID 811: an identification number of a shipment slip of the cargo 6. For example, the shipment slip ID 811 is represented by a combination of a numeric character, an alphabet character, and a symbol.

(11) Shipping date 812: a shipping date of the cargo 6.

(12) Shipment time 813: shipment time of the cargo 6. The shipping date 812 and the shipment time 813 may be integrated with each other.

(13) Time 814: time at which information about a temperature of the cargo 6 is obtained. For example, the time 814 represents time at which the terminal 7 takes an image of the identification label 81, 82, 83. In the case where the data logger 421 is used, the time 814 represents time at which the temperature of the cargo 6 is obtained by the data logger 421, and the time 814 represents, for example, the latest time at which the temperature is obtained.

(14) Position 815: a position at which information about a temperature of the cargo 6 is obtained. For example, the position 815 represents a coordinate obtained by a GPS included in the terminal 7.

(15) Image data 816: information about image data obtained by taking an image of the identification label 81, 82, 83 packed together with the cargo 6. For example, the image data 816 represents information indicating a link to a directory in which the image data is stored.

(16) Temperature 817: an optional item. For example, the temperature 817 can be used in a case where the data logger 421 is used. For example, the temperature 817 represents the latest temperature obtained by the data logger 421.

For example, the serial ID 801, the product name 802, the lot number 803, the expiration date 804, the product ID 805, the thermometer ID 806, the sender information 808, the destination information 809, the transport company information 810, the shipment slip ID 811, the shipping date 812, and the shipment time 813 are registered in the logistics management system 100 when the cargo 6 is sent. For example, the logistics management system 100 provides the application 500 with a notification indicating that the above-described information has been registered. For example, the logistics information obtaining portion 508 obtains the registered information from the logistics management system 100, according to the notification, and stores the obtained information in the database 80.

For example, when the block 510 including the data 513 is stored in the distributed ledger 51, the distributed ledger updating portion 506 of the application 500 according to the example of the present embodiment or embodiments may store information included in the data 513 of the block 510 in the database 80. The distributed ledger updating portion 506 stores, for example, the serial ID, the lot number, and the expiration date of the cargo 6, the identification information of the thermometer, the temperature information (presence or absence of the temperature deviation), the time information, the position information, and the image data (or link to the image data), as the serial ID 801, the lot number 803, the expiration date 804, the thermometer ID 806, the presence or absence of deviation 807, the time 814, the position 815, and the image data 816, respectively, in the database 80.

[Example of GUI]

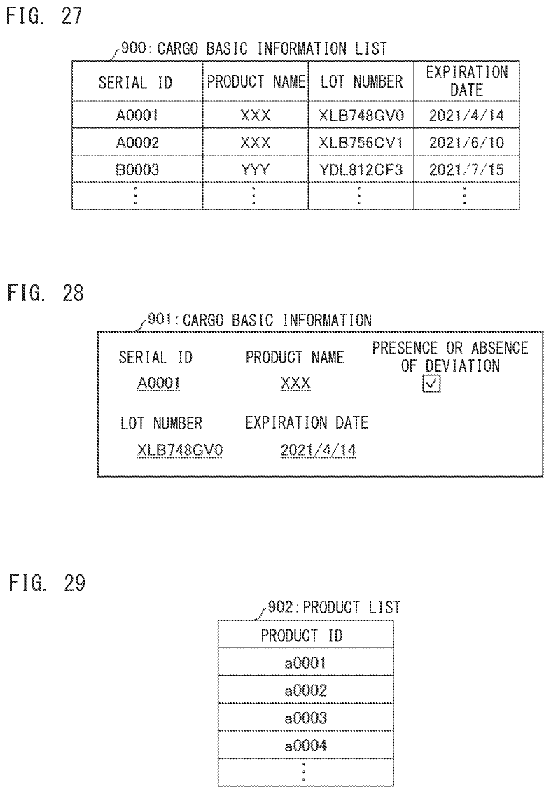

The GUI providing portion 507 provides, for example, a cargo basic information list 900 according to a request from the terminal 7 or the terminal 700. For example, the cargo basic information list 900 represents information in which the information (for example, serial ID, a product name, a lot number, an expiration date) about the cargo 6 is listed. FIG. 27 illustrates an example of the cargo basic information list 900. The GUI providing portion 507 specifies, for example, the user ID 800 corresponding to the user. The GUI providing portion 507 obtains, for example, information (for example, the serial ID 801, the product name 802, the lot number 803, the expiration date 804) associated with the specified user ID 800, from the database 80, and provides the cargo basic information list 900 including the above-described information to a terminal that has made the request.

In a case where a user requests to view details of the information in a state where a certain row in the cargo basic information list 900 is selected, for example, the GUI providing portion 507 provides cargo basic information 901 illustrated in FIG. 28, to the terminal that has made the request. The cargo basic information 901 is, for example, the information (for example, the serial ID 801, the product name 802, the lot number 803, the expiration date 804, the presence or absence of deviation 807) about the cargo 6 which corresponds to the selected row. FIG. 28 illustrates an example of the cargo basic information 901. The GUI providing portion 507 obtains, for example, the serial ID 801, the product name 802, the lot number 803, and the expiration date 804 from the database 80, and provides the cargo basic information 901 including the above-described information.

The GUI providing portion 507 obtains, for example, one or more product IDs 805 associated with the serial ID 801, from the database 80, and provides the terminal 7 or the terminal 700 with a product list 902 (see FIG. 29) including the information thereof. The product list 902 represents information in which the products IDs 805 are listed. FIG. 29 illustrates an example of the product list 902. The product list 902 is provided together with the cargo basic information 901 (for example, on one screen). The product list 902 may be provided separately from the cargo basic information 901 (for example, on a different screen).

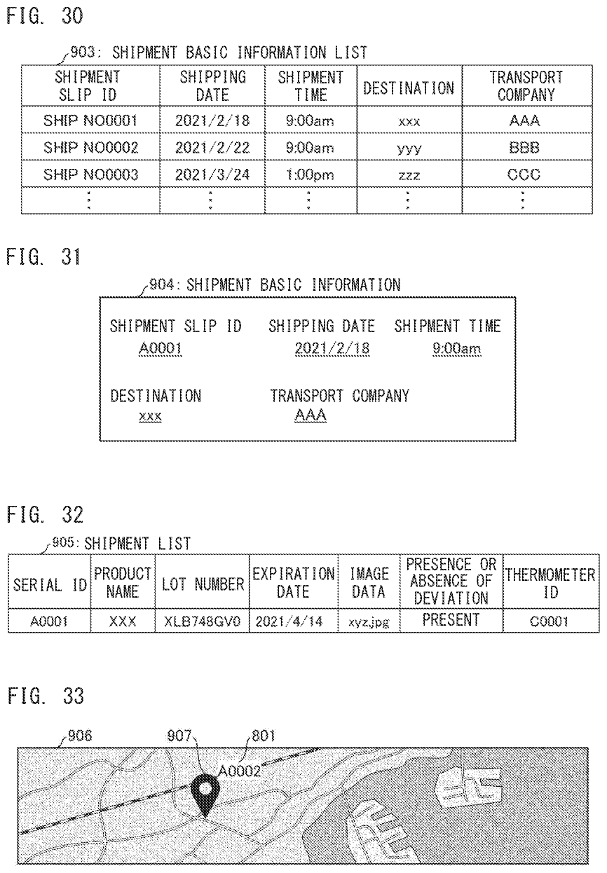

For example, the GUI providing portion 507 provides, according to a request from the terminal 7 or the terminal 700, a terminal that has made the request with a shipment basic information list 903 illustrated in FIG. 30. The shipment basic information list 903 represents, for example, information in which information (for example, the shipment slip ID 811, the shipping date 812, the shipment time 813, the destination information 809, the transport company information 810) about shipment of the cargo 6 is listed. FIG. 30 illustrates an example of the shipment basic information list 903. The GUI providing portion 507 specifies, for example, the user ID 800 corresponding to a user who utilizes the blockchain system 5, and the serial ID 801 associated with the user ID 800. For example, the GUI providing portion 507 obtains, from the database 80, information (for example, the shipment slip ID 811, the shipping date 812, the shipment time 813, the destination information 809, the transport company information 810) associated with the specified user ID 800 and serial ID 801, and provides the shipment basic information list 903 including the above-described information.

In a case where a user requests to view details of the information in a state where a certain row in the shipment basic information list 903 is selected, for example, the GUI providing portion 507 provides shipment basic information 904 illustrated in FIG. 31, to the terminal 7 or the terminal 700 that has made the request. For example, the shipment basic information 904 represents information (for example, the shipment slip ID 811, the shipping date 812, the shipment time 813, the destination information 809, the transport company information 810) about shipment of the cargo 6 which corresponds to the selected row. FIG. 31 illustrates an example of the shipment basic information 904. The GUI providing portion 507 obtains, for example, the shipment slip ID 811, the shipping date 812, the shipment time 813, the destination information 809, and the transport company information 810, from the database 80, and provides the shipment basic information 904 including the above-described information.

The GUI providing portion 507 obtains, for example, the serial ID 801 of the cargo 6 corresponding to the selected row and associated information thereof (for example, the product name 802, the lot number 803, the expiration date 804, the image data 816, the presence or absence of deviation 807, the thermometer ID 806), from the database 80, and provides the terminal 7 or the terminal 700 with a shipment list 905 (see FIG. 32) including the above-described information. FIG. 32 illustrates an example of the shipment list 905. The shipment list 905 is provided together with the shipment basic information 904 (for example, on one screen). The shipment list 905 may be provided separately from the shipment basic information 904 (for example, on a different screen).

For example, the GUI providing portion 507 may provide the terminal 7 or the terminal 700 with map information 906 illustrated in FIG. 33, in addition to the cargo basic information list 900. In a case where a user has selected a certain row in the cargo basic information list 900, the GUI providing portion 507 provides the map information 906. The GUI providing portion 507 obtains, for example, the position 815 associated with the user ID 800, from the database 80, and provides the map information 906 in which a predetermined mark 907 is superimposed and displayed on a position, on a map, corresponding to the obtained position 815. As illustrated in FIG. 33, for example, the GUI providing portion 507 may superimpose and display the serial ID 801 together with the mark 907. In a case where a plurality of rows in the cargo basic information list 900 are selected, the GUI providing portion 507 may provide the map information 906 in which information indicating each of positions of a plurality of selected cargos 6 is superimposed and displayed. The map information 906 is provided together with the cargo basic information list 900 (for example, on one screen). The map information 906 may be provided separately from the cargo basic information list 900 (for example, on a different screen).

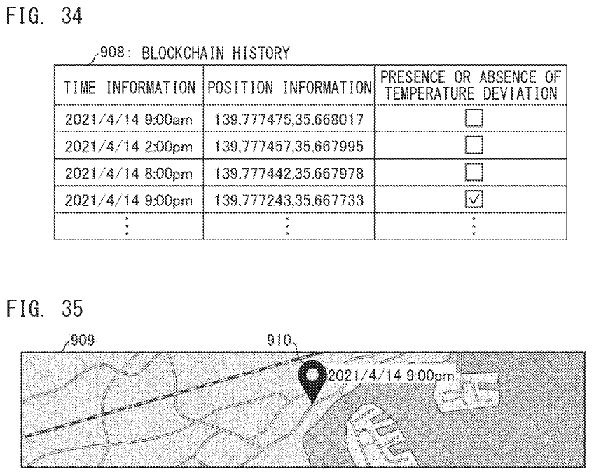

For example, the GUI providing portion 507 provides, according to a request from the terminal 7 or the terminal 700, a terminal that has made the request with a blockchain history 908 illustrated in FIG. 34. The blockchain history 908 represents information stored in the data 513 of each block 510 in the distributed ledger 51. For example, in a case where a user requests to view the blockchain history 908 in a state where a certain row in the cargo basic information list 900 is selected, the GUI providing portion 507 obtains the information about the cargo 6 corresponding to the selected row from each block 510 of the distributed ledger 51, and provides the blockchain history 908 including the above-described information, as in an example illustrated in FIG. 34. For example, the GUI providing portion 507 obtains the time information, the position information, and the temperature information (presence or absence of the temperature deviation) from the data 513 stored in each block 510 in the distributed ledger 51, and provides the above-described information as the blockchain history 908.

For any position information, in the blockchain history 908, selected by a user, the GUI providing portion 507 provides, for example, map information 909 illustrated in FIG. 35. The GUI providing portion 507 provides, for example, the map information 909 in which a predetermined mark 910 is superimposed and displayed on a position, on a map, corresponding to the selected position information. As illustrated in FIG. 35, the GUI providing portion 507 may superimpose and display, for example, the time information together with the mark 910.

[Effect Obtained by Providing Database 80]

As described above, an effect of enhancing retrieving efficiency is exhibited by managing the information about the cargo 6 with use of the database 80 in addition to the distributed ledger 51. For example, in a case where the information about the cargo 6 in which the temperature deviation has occurred is retrieved, if the distributed ledger 51 is searched, all of a plurality of the blocks 510 for each cargo 6 need to be searched. For example, in a case where the number of the cargos 6 is 1000 and the average number of the blocks 510 generated for one cargo 6 is 100, the 1000×100 blocks need to be searched. Meanwhile, in the database 80, the cargo 6 and the deviation information are associated with each other in a one-to-one correspondence. Specifically, as in the example illustrated in FIG. 26, the serial ID 801 and the presence or absence of deviation 807 are associated with each other in a one-to-one correspondence. Therefore, in a case where the cargo 6 in which the temperature deviation has occurred is to be retrieved, the serial ID 801 of the cargo 6 can be specified directly from the presence or absence of deviation 807. For example, in a case where the number of the cargos 6 is 1000, each of the 1000 cargos 6 is merely searched for a record in which the presence or absence of deviation 807 indicates “1” in the database 80. In this case, searching of the 1000 records suffices. Thus, information stored in the distributed ledger 51 is duplicated and stored in the database 80, thereby enhancing retrieving efficiency.

[Example of Application 500 According to Another Embodiment]

The identification label 81, 82, 83 (hereinafter, simply referred to also as “identification label”) corresponding to a temperature range in which the cargo 6 is to be managed is required to be packed together in the cargo 6 in order to determine whether temperature deviation of the cargo 6 is present or absent. If an identification label which does not correspond to a temperature range of the cargo 6 is erroneously packed in the cargo 6, whether temperature deviation of the cargo 6 is present or absent may not be correctly determined. For example, in a case where temperature deviation is to be determined to be absent by packing together the identification label corresponding to the temperature range of the cargo 6, temperature deviation may be determined to be present when an incorrect identification label is packed together. As the cargo 6, there are some cases where the same kind of cargo has different temperature ranges to be managed. For example, in a case where vaccines for the same disease (for example, SARS-CoV-2) are manufactured by different manufacturers, respectively, the temperature ranges to be managed for the vaccines may be different from each other. In the temperature management during transport of such a cargo 6, when whether or not the identification label corresponding to the temperature range in which the cargo 6 is to be managed is packed together in the cargo 6 can be confirmed, whether temperature deviation of the cargo 6 is present or absent is correctly determined. In the example of the present embodiment or embodiments, whether or not the identification label corresponding to the temperature range in which the cargo 6 is to be managed is packed together in the cargo 6, is confirmed by the application 500. For example, when the cargo 6 is sent from the sender 1, whether or not the identification label corresponding to the temperature range in which the cargo 6 is to be managed is packed together in the cargo 6 is confirmed by the application 500.

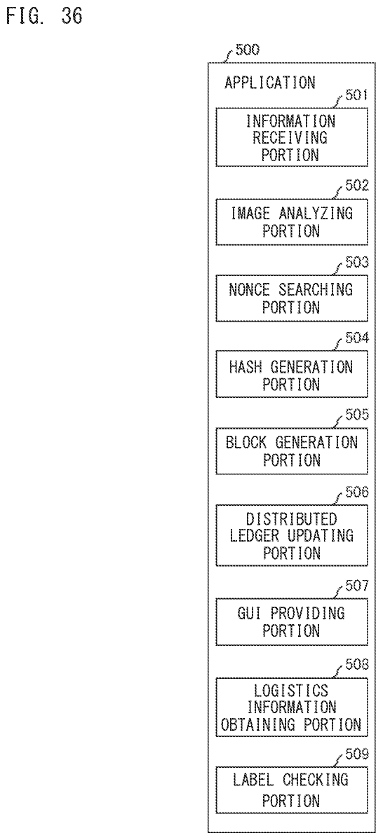

FIG. 36 illustrates an example of the application 500 according to another embodiment or embodiments. The application 500 illustrated in FIG. 36 includes a label checking portion 509. The other structure is the same as illustrated above in FIG. 18 and FIG. 24 and described with reference to the drawings.

The label checking portion 509 determines, for example, whether or not the identification label corresponding to the temperature range of the cargo 6 is packed together in the cargo 6. For example, the label checking portion 509 determines whether or not an appropriate identification label is packed together in the cargo 6 with reference to the thermometer ID 806 received from the terminal 7 and information in the database 80.

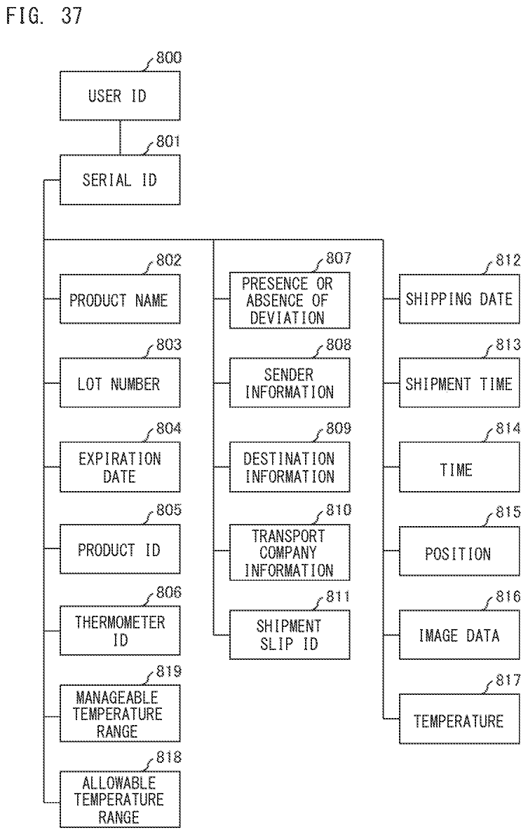

FIG. 37 illustrates an example of a data structure of the database 80 according to the present embodiment or embodiments. In the database 80 illustrated in FIG. 37, an allowable temperature range 818 and a manageable temperature range 819 in addition to the information illustrated in FIG. 26 are associated with the serial ID 801. The allowable temperature range 818 represents a temperature range in which the cargo 6 is to be managed. The allowable temperature range 818 is associated with the thermometer ID 806. For example, in a case where the temperature range in which the cargo 6 is to be managed is “2° C. to 8° C”, the allowable temperature range 818 indicating 2° C. to 8° C. is associated with the thermometer ID 806 and stored in the database 80. For example, in a case where the temperature range in which the cargo 6 is to be managed is “−70° C. or lower”, the allowable temperature range 818 indicating −70° C. or lower is associated with the thermometer ID 806 and stored in the database 80. The allowable temperature range 818 is, for example, registered in the logistics management system 100 when the cargo 6 is sent, and is obtained from the logistics management system 100 and stored in the database 80 by the application 500. The allowable temperature range 818 may be read from the information storage portion 410, 420, 430 attached to the identification label 81, 82, 83 and transmitted to the server 50 by the terminal 7.

For example, the label checking portion 509 obtains the thermometer ID 806 with reference to the information in the database 80 illustrated in FIG. 37. The label checking portion 509 searches the database 80 by using information (for example, the serial ID 801), about the cargo 6, received from the terminal 7 as a key, and obtains the thermometer ID 806 corresponding to the cargo 6. For example, the label checking portion 509 may obtain the thermometer ID 806 from the terminal 7. For example, the terminal 7 reads the thermometer ID 806 from the information storage portion 410, 420, 430 attached to the identification label 81, 82, 83, and transmits the read thermometer ID 806 to the server 50. The label checking portion 509 obtains the thermometer ID 806 transmitted from the terminal 7.

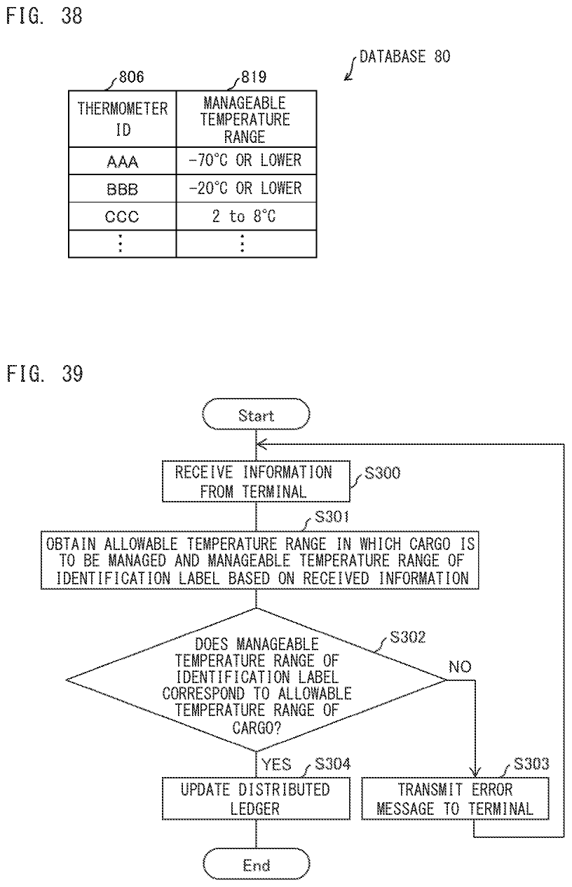

The label checking portion 509 obtains the manageable temperature range 819 of the identification label based on the obtained thermometer ID 806. The manageable temperature range 819 represents a temperature range in which whether temperature deviation is present or absent can be detected by the identification label. For example, in a case where the manageable temperature range 819 of the identification label is “0° C. to 10° C”, it is determined by the identification label that “temperature deviation is absent” when the temperature of the cargo 6 to which the identification label is attached ranges from 0° C. to 10° C. In a case where the cargo 6 is exposed to a temperature outside the above-described range, it is determined by the identification label that “temperature deviation is present”. For example, the label checking portion 509 obtains the manageable temperature range 819 with reference to the database 80. FIG. 38 illustrates an example of information of the manageable temperature range 819 associated with the thermometer ID 806. As in the example illustrated in FIG. 38, the corresponding manageable temperature range 819 is associated with the thermometer ID 806. For example, when the cargo 6 is sent, both the manageable temperature range 819 and the thermometer ID 806 are registered in the logistics management system 100, and the logistics information obtaining portion 508 of the application 500 obtains the manageable temperature range 819 from the logistics management system 100 and stores the manageable temperature range 819 in the database 80. The manageable temperature range 819 may be read from the information storage portion 410, 420, 430 attached to the identification label 81, 82, 83 and transmitted to the server 50 by the terminal 7. For example, the label checking portion 509 searches the database 80 by using the obtained thermometer ID 806 as a key, and obtains the manageable temperature range 819 associated with the thermometer ID 806.

The label checking portion 509 obtains the allowable temperature range 818 of the transported cargo 6. For example, the label checking portion 509 obtains the allowable temperature range 818 of the cargo 6 based on the information (for example, the serial ID 801 of the cargo 6) received from the terminal 7. For example, the label checking portion 509 searches the database 80 by using, as a key, the serial ID 801 received from the terminal 7, and obtains the allowable temperature range 818 associated with the serial ID 801. An example of the structure of the database 80 is as illustrated in FIG. 37.

The label checking portion 509 compares the allowable temperature range 818 of the cargo 6 and the manageable temperature range 819 of the identification label packed together in the cargo 6 with each other, and determines whether or not the manageable temperature range 819 corresponds to the allowable temperature range 818 (in other words, whether or not the identification label corresponding to the allowable temperature range 818 of the cargo 6 is packed together in the cargo 6). For example, the label checking portion 509 determines whether or not deviation from the allowable temperature range 818 can be determined by the identification label having the manageable temperature range 819. For example, in a case where the allowable temperature range 818 is “−70° C. or lower”, the label checking portion 509 determines whether or not temperature deviation can be determined to be present by the identification label having the manageable temperature range 819 when the temperature of the cargo 6 becomes higher than −70° C. For example, in a case where the manageable temperature range 819 is “−100° C. or higher and −70° C. or lower”, the label checking portion 509 determines whether presence or absence of temperature deviation of the cargo 6 for which the allowable temperature range 818 is “−70° C. or lower” can be determined.

For example, in a case where it is determined that the manageable temperature range 819 of the identification label packed together in the cargo 6 does not correspond to the allowable temperature range 818 of the cargo 6, the label checking portion 509 may notify the terminal 7 of an error message. In a case where the label checking portion 509 notifies the terminal 7a of the error message when the cargo 6 is sent, a person in charge of sending the cargo 6 can be promoted to change the identification label to an appropriate identification label. For example, the label checking portion 509 makes notification of an error message indicating that “the identification label does not correspond to the temperature range of the cargo 6, and whether temperature deviation is present or absent cannot be determined. Please change the label to an appropriate identification label and upload information again.” This error message is illustrative, and the content of the message is not limited thereto.

In a case where the label checking portion 509 determines that the manageable temperature range 819 of the identification label packed together in the cargo 6 corresponds to the allowable temperature range 818 of the cargo 6, the image analyzing portion 502, the nonce searching portion 503, the hash generation portion 504, the block generation portion 505, and the distributed ledger updating portion 506 may execute processes for updating the distributed ledger 51. Only when an appropriate identification label is packed together in the cargo 6, the distributed ledger 51 is updated, thereby inhibiting formation of a blockchain based on incorrect information.

FIG. 39 is a flow chart showing an example of a flow of a process executed by the application 500 according to the present embodiment or embodiments.

Information is received from the terminal 7 by the application 500 (S300). For example, (i) information (for example, the serial ID 801 of the cargo 6) about the cargo 6 and (ii) the thermometer ID 806, are received from the terminal 7 by the application 500.

For example, the label checking portion 509 of the application 500 obtains the allowable temperature range 818 of the cargo 6 and the manageable temperature range 819 of the identification label, based on the information received from the terminal 7 (S301).

For example, the label checking portion 509 of the application 500 determines whether or not the manageable temperature range 819 of the identification label corresponds to the allowable temperature range 818 of the cargo 6 (in other words, whether or not the identification label corresponding to the temperature range in which the cargo 6 is to be managed is packed together in the cargo 6) based on the allowable temperature range 818 and the manageable temperature range 819 (S302). “The manageable temperature range 819 of the identification label corresponds to the allowable temperature range 818 of the cargo 6” indicates that a temperature range indicated by the manageable temperature range 819 of the identification label is included in the temperature range indicated by the allowable temperature range 818 of the cargo 6. For example, in a case where the allowable temperature range 818 is “−70° C. or lower”, and the manageable temperature range 819 is “−70° C. or lower”, the manageable temperature range 819 corresponds to the allowable temperature range 818. Similarly, in a case where the allowable temperature range 818 is “−70° C. or lower”, and the manageable temperature range 819 is, for example, “−100° C. or higher and −70° C. or lower”, the manageable temperature range 819 corresponds to the allowable temperature range 818. Meanwhile, in a case where the allowable temperature range 818 is “−70° C. or lower”, and the manageable temperature range 819 is, for example, “−50° C. or higher”, the manageable temperature range 819 does not correspond to the allowable temperature range 818.

For example, in a case where it is determined that the manageable temperature range 819 of the identification label does not correspond to the allowable temperature range 818 of the cargo 6 (in other words, the identification label corresponding to the temperature range in which the cargo 6 is to be managed is not packed together in the cargo 6) (No in S302), the label checking portion 509 of the application 500 transmits an error message to the terminal 7 (S303).

For example, in a case where the manageable temperature range 819 of the identification label is determined to correspond to the allowable temperature range 818 of the cargo 6 (in other words, the identification label corresponding to the temperature range in which the cargo 6 is to be managed is packed together in the cargo 6) (Yes in S302), the image analyzing portion 502, the nonce searching portion 503, the hash generation portion 504, the block generation portion 505, and the distributed ledger updating portion 506 of the application 500 execute processes for updating the distributed ledger 51 (S304).

The invention is not limited to the embodiments described above, and various modifications can be made without departing from the scope of the claims. Embodiments obtained by combining as appropriate technological means disclosed in different embodiments are also included in the technological scope of the invention.

1. A management method for managing temperature information of a transported cargo by a blockchain system, the management method comprising:
obtaining, by a terminal of a user who uses the blockchain system, data about a temperature from a thermometer transported together with the cargo, and
transmitting, by the terminal, the data to the blockchain system in order to register information about presence or absence of temperature deviation.

2. The management method of claim 1, wherein
the terminal communicates with the blockchain system via an application installed on the terminal.

3. The management method of claim 1, wherein communication with the blockchain system is permitted by an application installed on the terminal in a case where authentication of the user succeeds.

4. The management method of claim 1, wherein
the terminal obtains the data by an application installed on the terminal.

5. The management method of claim 1, wherein
the terminal transmits the data to the blockchain system by an application installed on the terminal.

6. The management method of claim 1, wherein the data obtained by the terminal is transmitted to the blockchain system according to an operation performed by the user.

7. The management method of claim 1, wherein a screen about an operation of obtaining the data is displayed on the terminal.

8. The management method of claim 1, wherein an operation procedure about obtaining the data is displayed on the terminal.

9. The management method of claim 1, wherein the terminal is a hand-held terminal.

10. The management method of claim 1, wherein the data is image data obtained by taking an image of the thermometer by the terminal.

11. The management method of claim 10, wherein
the thermometer comprises a temperature indicator, and
the image data is obtained by taking an image of the temperature indicator.

12. The management method of claim 11, wherein
the temperature indicator comprises a temperature detecting ink, and
the image data is obtained by taking an image of the temperature detecting ink.

13. The management method of claim 1, wherein
the thermometer comprises a data logger for measuring temperatures of the cargo being transported, at predetermined time intervals, and storing the temperatures, and
the data represents a record of the temperatures measured at the predetermined time intervals.

14. The management method of claim 1, wherein
the terminal obtains the data by contactless communication with the thermometer.

15. The management method of claim 1, wherein
the terminal
reads information about the cargo, from an information code transported together with the cargo, and
transmits the read information about the cargo to the blockchain system.

16. The management method of claim 15, wherein
the information code is attached to the cargo, and
the terminal
reads the information about the cargo from the information code attached to the cargo, and
transmits the read information about the cargo to the blockchain system.

17. The management method of claim 15, wherein
the data and the information about the cargo are associated with each other and transmitted to the blockchain system by the terminal.

18. The management method of claim 1, wherein
the terminal
obtains position information indicating a position of the terminal located at a point of time when the data is obtained, and
transmits the position information and the data to the blockchain system.

19. The management method of claim 1, wherein
the terminal
obtains time information indicating time at which the data is obtained, and
transmits the time information and the data to the blockchain system.

20. The management method of claim 1, wherein
the terminal of each of a plurality of the users obtains the data and transmits the data to the blockchain system.

21. The management method of claim 1, wherein
the terminal
obtains an allowable temperature range in which the cargo is to be managed, an ID indicating the thermometer, and a manageable temperature range of an identification label of the cargo; and
transmits the allowable temperature range, the ID, and the manageable temperature range to the blockchain system in order to determine whether or not information about presence or absence of temperature deviation is to be registered.

22. A management method for managing temperature information of a transported cargo by a blockchain system, the management method comprising:
receiving, by the blockchain system, data about a temperature which is obtained from a thermometer transported together with the cargo, from a terminal of a user who uses the blockchain system; and
registering, by the blockchain system, information about presence or absence of temperature deviation based on the data.

23. The management method of claim 22, wherein
the blockchain system communicates with the terminal via an application installed on the terminal.

24. The management method of claim 22, wherein
the blockchain system communicates with the terminal in a case where authentication of the user succeeds by an application installed on the terminal.

25. The management method of claim 22, wherein
the blockchain system receives the data obtained by an application installed on the terminal.

26. The management method of claim 22, wherein
the blockchain system receives the data transmitted by an application installed on the terminal.

27. The management method of claim 22, wherein
the blockchain system receives the data which is obtained by the terminal and transmitted by an operation performed by the user.

28. The management method of claim 22, wherein the data is image data obtained by taking an image of the thermometer by the terminal.

29. The management method of claim 28, wherein
the thermometer comprises a temperature indicator, and
the image data is obtained by taking an image of the temperature indicator.

30. The management method of claim 29, wherein
the thermometer comprises a temperature detecting ink, and
the image data is obtained by taking an image of the temperature detecting ink.

31. The management method of claim 22, wherein
the thermometer comprises a data logger for measuring temperatures of the cargo being transported, at predetermined time intervals, and storing the temperatures, and
the data represents a record of the temperatures measured at the predetermined time intervals.

32. The management method of claim 22, wherein
from the terminal, the blockchain system further receives information, about the cargo, read from an information code transported together with the cargo.

33. The management method of claim 32, wherein
the information code is attached to the cargo, and
from the terminal, the blockchain system receives the information, about the cargo, read from the information code attached to the cargo.

34. The management method of claim 32, wherein
the blockchain system receives the data and the information about the cargo from the terminal in a state where the data and the information about the cargo are associated with each other.

35. The management method of claim 22, wherein
information about the cargo and the information about presence or absence of temperature deviation are associated with each other and registered by the blockchain system.

36. The management method of claim 35, wherein
the blockchain system
receives, from the terminal, an allowable temperature range in which the cargo is to be managed, and an ID indicating the thermometer, and
determines whether or not the information about presence or absence of temperature deviation is to be registered, based on the allowable temperature range, and a manageable temperature range associated with the ID.

37. The management method of claim 22, wherein a plurality of blocks included in the blockchain system are associated with each other based on information about the cargo.

38. The management method of claim 22, wherein
the blockchain system receives the data from the terminal of each of a plurality of the users and registers the information.

39. A management method for managing temperature information of a transported cargo by a blockchain system, the management method comprising:
obtaining, by a terminal of a user who uses the blockchain system, data about a temperature from a thermometer transported together with the cargo;
transmitting, by the terminal, the data to the blockchain system; and
registering, by the blockchain system, information about presence or absence of temperature deviation based on the data.

40. A terminal device of a user who uses a blockchain system for managing temperature information of a transported cargo, the terminal device comprising
a controller, wherein
the controller is programmed to:
obtain data about a temperature from a thermometer transported together with the cargo; and
transmit the data to the blockchain system in order to register information about presence or absence of temperature deviation.

41. An information processing apparatus included in a blockchain system for managing temperature information of a transported cargo, the information processing apparatus comprising
a controller, wherein
the controller is programmed to:
receive data about a temperature which is obtained from a thermometer transported together with the cargo, from a terminal of a user who uses the blockchain system; and
register information about presence or absence of temperature deviation based on the data.

42. A non-transitory computer-readable storage medium storing a program for a user terminal used in a blockchain system to perform managing temperature information of a transported cargo, the program, which when read and executed, causes a computer to perform operations comprising:
obtaining data about a temperature from a thermometer transported together with the cargo; and
transmitting the data to the blockchain system for registering information about presence or absence of temperature deviation.

43. A non-transitory computer-readable storage medium storing a program for an information processing apparatus included in a blockchain system to perform managing temperature information of a transported cargo, the program, which when read and executed, causes a computer to perform operations comprising:
receiving data about a temperature which is obtained from a thermometer transported together with the cargo; and
registering information about presence or absence of temperature deviation based on the data.

44. A method for manufacturing a system for managing temperature information of a transported cargo, the method comprising
providing a user terminal of a user who uses a blockchain system with a program for executing a process of obtaining data about a temperature from a thermometer transported together with the cargo, and a process of transmitting the data to the blockchain system to register information about presence or absence of temperature deviation, in order to install the program on the terminal.

45. A method for manufacturing a system for managing temperature information of a transported cargo, the method comprising
providing an information processing apparatus included in a blockchain system with a program for executing a process of receiving data about a temperature which is obtained from a thermometer transported together with the cargo, and a process of registering information about presence or absence of temperature deviation based on the data, in order to install the program on the information processing apparatus.
